(19) United States
(12) Patent Application Publication
(10) Pub. No.: US 2006/0209485 A1
(43) Pub. Date: Sep. 21, 2006

(54) Discharge tube and surge absorbing device

(75) Inventors: Koichi Imai, SAITAMA (JP); Satoshi Hori, Saitama (JP); Yoichi Matsuyama, Saitama (JP); Yoshikazu Hanamura, Saitama (JP)

Correspondence Address: ANDREW F. YOUNG, LACKENBAUGH SIEGEL, LLP, ONE CHASE ROAD, SCARSDALE, NY, 10583, US

(73) Assignee: OKAYA ELECTRIC INDUSTRIES CO., LTD., TOKYO (JP)

(21) Appl. No.: 10/549,586

(22) PCT Filed: Apr. 1, 2004
(86) PCT No.: PCT/JP04/04785

§ 371 Date: Sep. 19, 2005

(30) Foreign Application Priority Data
Apr. 10, 2003 (JP) 2003-106883
Jun. 4, 2003 (JP) 2003-159501
Jun. 30, 2003 (JP) 2003-186739
Jul. 9, 2003 (JP) 2003-272213
Jul. 9, 2003 (JP) 2003-277434
Dec. 25, 2003 (JP) 2003-430223

(51) Int. Cl. H02H 9/06

(52) U.S. Cl. 361/120

(57) ABSTRACT

A discharge tube 10 formed by forming an airtight envelope 16 by hermetically sealing openings at both ends of a case member 12 made of an insulating material opened at both ends with a pair of cap members 14, 14 that double a discharge electrode, forming a predetermined discharge gap 22 between discharge electrode portions 18, 18 of the cap members 14, 14, forming on an inner wall surface 24 of the case members 12 a plurality of linear triggering discharge films 28 of which both ends are disposed separated by a small discharge gap 26 opposite to the cap members 14, 14 that double a discharge electrode, forming on a surface of the discharge electrode portion 18 a film 30 containing an alkali iodide, and encapsulating a discharge gas containing Kr (krypton) in the airtight envelope 16.

### TECHNICAL FIELD

The present invention relates to; a discharge tube that can be preferably used as a switching spark gap for supplying a turning-on or igniting constant voltage to a high-pressure discharge lamp such as a metal halide lamp for projectors and automobiles or an ignition plug of a gas cooker, or a gas arrestor (lighting conductor) for absorbing a surge voltage; and a surge absorber that absorbs a surge such as an indirect lighting stroke by making use of a discharge phenomenon in a discharge gap sealed in an air-tight envelope to inhibit an electronic instrument from being damaged, in particular, uses a creeping corona discharge as triggering means to aerial discharge.

### BACKGROUND ART

So far, as a switching spark gap for supplying a turning-on or igniting constant voltage to a high-pressure discharge lamp such as a metal halide lamp for projectors and automobiles or an ignition plug of gas cookers, a discharge tube has been used.

Furthermore, so far, as a surge absorber that protects electric circuits of an electric instrument from surges such as an indirect lighting stroke, various surge absorbers such as a varistor made of a high resistive element having the voltage non-linearity characteristics and a gas arrestor that accommodates a discharge gap in an airtight vessel are in use. Among such surge absorbers, in order to realize high responsiveness, many surge absorbers that use the creeping corona discharge as the triggering discharge are used.

As such a discharge tube or surge absorber, present inventors have previously proposed JP-A No. 2003-7420. In the discharge tube (surge absorber) 60, an airtight envelope 66 is formed, as shown in FIG. 27, by hermetically clogging openings at both ends of a cylindrical case member 62 made of an insulating material opened at both ends thereof with a pair of cap members 64, 64 that double as a discharge electrode, followed by encapsulating a predetermined discharge gas in the airtight envelope 66.

The cap member 64 includes a planar discharge electrode portion 68 largely protruded toward a center of the airtight envelope 66 and a connection portion 70 that is in contact with an end surface of the case member 62. Between discharge electrode portions 68, 68 of both cap members 64, 64, a predetermined discharge gap 72 is formed.

Furthermore, on an inner wall surface 74 of the case member 62, a plurality of sets of a pair of triggering discharge films 78, 78 disposed oppositely separated by a small discharge gap 76 is formed. One triggering discharge film 78 of the pair of triggering discharge films 78, 78 is brought into electrical contact with one discharge electrode portion 68, and the other triggering discharge film 78 is brought into electrical contact with the other discharge electrode portion 68.

On a surface of the discharge electrode portion 68, an insulating film 80 that contains an alkali iodide effective for stabilizing the discharge start voltage is formed. As the alkali iodide, a simple substance of alkali iodides such as potassium iodide (KI), sodium iodide (NaI), cesium iodide (CsI) and rubidium iodide (RbI) or a mixture thereof can be cited.

As a discharge gas that is encapsulated in the airtight envelope 66, a simple substance of rare gases such as argon, neon, helium and xenon or an inert gas such as nitrogen gas or a mixture thereof can be cited. Furthermore, a mixture of a simple substance or a mixture of rare gases or inert gases and a negative polarity gas such as H₂ can be cited.

When between the discharge electrode portions 68, 68 of the discharge tube 60 thus configured, a voltage equal to or higher than the discharge start voltage of the discharge tube 60 is applied, an electric field is concentrated at the small discharge gap 76 between the triggering discharge films 78, 78, and thereby electrons are released in the small discharge gaps 76 and thereby the creeping corona discharge as the triggering discharge is generated. Subsequently, the creeping corona discharge shifts to the glow discharge owing to a priming effect of electrons. Then, the glow discharge spreads to a discharge gap 72 between the discharge electrode portions 68, 68, and shifts to an arc discharge as a primary discharge.

Furthermore, when a surge is applied to a surge absorber 60 provided with the foregoing configuration, an electric field is concentrated at the small discharge gap 76 between the triggering discharge films 78, 78, and thereby electrons are released in the small discharge gap 76 to generate the creeping corona discharge as the triggering discharge. In the next place, the creeping corona discharge shifts to the glow discharge owing to the priming effect of electrons. Then, the glow discharge spreads to the discharge gap 72 between the discharge electrode portions 68, 68 and shifts to the arc discharge as the primary discharge to absorb the surge.

In the existing discharge tube (surge absorber) 60, since the film 80 that contains an alkali iodide effective in stabilizing the discharge start voltage is formed on a surface of the discharge electrode portion 68, even when it is operated at such a short interval as several microseconds or a surge voltage short in the buildup time is applied, a stable discharge start voltage can be always obtained.

Furthermore, in the foregoing discharge tube (surge absorber) 60, since even when the number of discharges reaches substantially two million times, the discharge start voltage does not exhibit such a large change, the lifetime of the discharge tube (surge absorber) 60 can be made longer.

(1) As mentioned above, when the film 80 that contains an alkali iodide effective in stabilizing the discharge start voltage is formed on a surface of the discharge electrode portion 68 of the discharge tube 60, a discharge tube relatively longer in the lifetime can be realized.

However, since the lifetime characteristics of the existing discharge tube 60 is not necessarily at a satisfying level, a discharge tube having a further longer lifetime is expected.

The invention was carried out to cope with the foregoing demand and firstly intends to realize a discharge tube that can improve the lifetime characteristics.

(2) Furthermore, in the existing discharge tube 60, as a constituent material of the discharge electrode portion 68, oxygen-free copper is widely used. This is because a discharge electrode portion 68 constituted of oxygen-free copper does not liberate impurity gases such as oxygen at the time of discharge generation and thereby does not adversely affect on a discharge gas composition inside of the airtight envelope 66.

Now, the softening temperature (melting temperature) of the oxygen-free copper is substantially 200° C. When the discharge electrode portion 68 is formed of the oxygen-free copper as mentioned above, the discharge electrode portion 68 is exposed to high temperature thermal energy at the time of discharge generation; accordingly, the discharge electrode portion 68 made of the oxygen-free copper is melted and sprinkled to cause sputtering. The generation of the sputtering is a primary cause of shortening the lifetime of the discharge tube 60.

The invention was carried out in view of the above situations and secondarily intends to suppress the discharge electrode from sputtering to improve the lifetime characteristics of the discharge tube.

(3) Still furthermore, when the discharge electrode portion 68 is formed of the oxygen-free copper, the following discharge start voltage is lowered, resulting in shortening the lifetime of the discharge tube 60.

The invention was carried out in view of the above situations and thirdly intends to realize a longer lifetime discharge tube that does not cause the lowering of the following discharge start voltage.

(4) In the existing discharge tube 60, as shown in FIG. 28, in a circumferential direction of the inner wall surface 74 of the case member 62, four sets of a pair of triggering discharge films 78, 78 oppositely disposed separated by the small discharge gap 76 are formed at an interval of 90°. As a constituent material of the triggering discharge film 78, a carbon base material primarily made of particulate graphite is widely used. The triggering discharge film 78 is formed by rubbing a core material made of a carbon base material having, for instance, graphite as a primary raw material on an inner wall surface 74 of the case member 62.

Now, when the discharge tube 60 is left to stand for a long time, a slight amount of impurity gases contained in the discharge gas and impurity gases mingled in the course of sealing the airtight envelope 66 are absorbed on a surface of the discharge electrode portion 68 and the film 80; thereby, the work functions of the discharge electrode portion 68 and the film 80 are caused to change, resulting in, in some cases, raising the initial discharge start voltage to cause a delay in the initial discharge.

The triggering discharge film 78 is formed to supply initial electrons to carry out a function of inhibiting the initial discharge from delaying. However, the existing triggering discharge films 78, 78 formed, as shown in FIG. 28, by forming four sets at an interval of 90° in a circumferential direction of the inner wall surface 74 of the case member 62 could not necessarily sufficiently inhibit the initial discharge from delaying.

Furthermore, the existing triggering discharge film 78 constituted of a carbon base material of which primary raw material is graphite could not necessarily sufficiently inhibit the initial discharge from delaying. Still furthermore, the triggering discharge film 78 constituted of a carbon base material of which primary raw material is particulate graphite, being small in the adhesive force with the inner wall surface 74 of the case member 62 to be readily peeled off owing to the impact at the time of energizing, did not in some times fulfill the function of inhibiting the initial discharge from delaying.

The invention was carried out in view of the above situations and fourthly intends to realize a longer lifetime discharge tube that can inhibit the initial discharge start voltage from going up and does not cause the delay in the initial discharge.

(5) In the existing discharge tube 60, the film 80 that contains an alkali iodide, being small in the work function and excellent in the electron emission characteristics, works so as to lower the discharge start voltage. In particular, when one in which potassium iodide (KI) is added to a binder made of a sodium silicate solution and pure water is coated on a surface of the discharge electrode portion 68 to form the film 80, the discharge start voltage can be preferably and remarkably lowered.

However, when one in which potassium iodide (KI) is added to a binder made of a sodium silicate solution and pure water is used to form the film 80, it was found that when the discharge tube 60 is used under a high temperature condition, in some cases, the discharge start voltage fluctuates largely.

The invention was carried out in view of the above situations and fifthly intends to realize a discharge tube that, in the discharge tube in which the film is formed by coating one in which potassium iodide is added to a binder made of a sodium silicate solution and pure water on a surface of the discharge electrode, can suppress the change rate of the discharge start voltage when used under a high temperature condition.

(6) Furthermore, in the existing surge absorber 60, the triggering discharge films 78, 78 are electrically connected with the cap members 64, 64 provided with the discharge electrode portions 68, 68 and a pair of triggering discharge films 78, 78 is oppositely disposed with a separation of the small discharge gap 76. Accordingly, since a degree of concentration of the electric field in the small discharge gap 76 is strong and thereby electrons are liberated a lot, the discharge start voltage can be effectively lowered. However, an electrode material sprinkled owing to the sputtering of the discharge electrode portion 68 at the time of discharge generation adheres to the small discharge gap 76 between the oppositely disposed pair of the triggering discharge films 78, 78 and tends to cause insulation deterioration between the triggering discharge films 78, 78.

The invention was carried out in view of the above situations and sixthly intends to realize a long lifetime surge absorber that can inhibit the insulation deterioration form occurring.

### DISCLOSURE OF THE INVENTION

In order to achieve the first object, inventors, after variously studying composite materials of a discharge gas encapsulated in an airtight envelope, found that Kr (krypton) that is large in the atomic weight and small in the thermal conductivity is very effective in improving the lifetime characteristics of a discharge tube, and thereby came to completion of the invention.

That is, a discharge tube described in claim 1 is characterized in that a plurality of discharge electrodes is disposed separated by a discharge gap in an airtight envelope and a discharge gas containing Kr is encapsulated in the airtight envelope.

In the discharge tube described in claim 1, since a discharge gas containing Kr that is large in the atomic weight and small in the thermal conductivity is encapsulated in the airtight envelope, the discharge electrode can be suppressed from being consumed owing to the sputtering, resulting in an improvement in the lifetime characteristics of the discharge tube. Reasons below are considered for this.

That is, a discharge electrode on a negative electrode side of a discharge tube is sputtered owing to an impact of positive ions always during the discharge generation. As a result, an electrode material of the discharge electrode on the negative electrode side is sputtered in an atomic state and adheres to the discharge electrode and an inner wall of an airtight envelope to blacken. Thereby, a surface leakage current and an inner wall potential of the airtight envelope are altered to shorten the lifetime of the discharge tube.

However, since Kr is large in the atomic weight, an acceleration when Kr ions ionized when the discharge is generated go toward a discharge electrode on the negative electrode side is small, that is, a shifting speed of Kr ions is slow. Accordingly, during shifting, Kr ions return to a ground state or collide with other molecules to cause conversion into thermal energy. As a result, the impact imparted on the discharge electrode on the negative electrode side is considered small to be able to suppress the discharge electrode from being consumed owing to the sputtering.

Furthermore, since Kr is small in the thermal conductivity, when the Kr ions collide with the discharge electrode, heat is difficult to be conducted to the discharge electrode; accordingly, the discharge electrode is melted owing to heat with difficulty. As a result, when a discharge gas contains Kr, at the time of discharge generation, even when the Kr ions collide with the discharge electrode, the discharge electrode is considered inhibited from causing the sputtering where the discharge electrode is melted and sputtered.

In the discharge tube described in claim 1, the discharge gas may be constituted of a mixture gas of Kr and H₂. When the discharge gas is thus constituted of a mixture gas of Kr and H₂, owing to H₂ that is small in the atomic weight and a negative polarity gas, the discharge delay and a following current phenomenon where the discharge is maintained can be effectively inhibited.

Furthermore, in the discharge tube described in claim 1, the discharge gas may be constituted of a mixture gas of Kr and Ar. When the discharge gas is thus constituted of a mixture gas of Kr and Ar, owing to Ar that is small in the atomic weight, the discharge delay can be effectively inhibited.

Still furthermore, in the discharge tube described in claim 1, the discharge gas may be constituted of a mixture gas of Kr and Ne. When the discharge gas is thus constituted of a mixture gas of Kr and Ne, owing to Ne that has an operation of lowering the discharge start voltage, the discharge generation becomes easier.

In order to achieve the second object, the inventors, after trying to variously study constituent materials of the discharge electrode, found that zirconium copper obtained by containing zirconium in oxygen-free copper suppresses the discharge electrode from being sputtered and is very effective in improving the lifetime characteristics of the discharge tube, and thereby the invention came to completion.

That is, the discharge tube described in claim 5 is characterized in that, in a discharge tube where a plurality of discharge electrodes is disposed separated by a discharge gap and this is encapsulated in an airtight envelope together with a discharge gas, the discharge electrode is constituted of zirconium copper obtained by containing zirconium in oxygen-free copper.

In the discharge tube described in claim 5, since the discharge electrode is constituted of zirconium copper obtained by containing zirconium in oxygen-free copper, in comparison with an existing discharge tube 60 of which discharge electrode is constituted of oxygen-free copper, the lifetime characteristics of the discharge tube can be improved. This is due to reasons below.

That is, a discharge electrode on a negative electrode side is subjected to an impact of positive ions and high temperature thermal energy always when the discharge is generated, and thereby, an electrode material of the discharge electrode is melted and sputtered to cause sputtering. As a result, the electrode material of the discharge electrode on the negative electrode side adheres to the discharge electrode and an inner wall of an airtight envelope to blacken. Thereby, a surface leakage current and an inner wall potential of the airtight envelope are altered to shorten the lifetime of the discharge tube.

However, zirconium copper obtained by containing zirconium in oxygen-free copper has a softening temperature (melting temperature) at substantially 500° C., substantially 2.5 times higher than substantially 200° C. of the softening temperature (melting temperature) of the oxygen-free copper. Accordingly, when the discharge electrode is constituted of zirconium copper, the thermal energy resistance of the discharge electrode is improved, the discharge electrode is suppressed from being consumed owing to the sputtering, resulting in improving the lifetime characteristics of the discharge tube.

In order to achieve the third object, the inventors, after trying to variously study constituent materials of the discharge gas and encapsulation gas pressures of the discharge gas, found that when the discharge gas is constituted of a simple substance of argon and a pressure of the encapsulation gas is set in the range of 0.3 to 5 atmospheric pressures, the following discharge start voltage can be inhibited from lowering and the lifetime characteristics of the discharge tube can be effectively improved. Thereby, the invention came to completion.

That is, a discharge tube described in claim 6 is characterized in that, in a discharge tube where a plurality of discharge electrodes constituted of oxygen-free copper is disposed separated by a discharge gap and this is sealed in an airtight envelope together with a discharge gas, the discharge gas is constituted of argon and the argon is encapsulated in the airtight envelope at a pressure in the range of 0.3 to 5 atmospheric pressures.

In the discharge tube described in claim 6, since the discharge gas is constituted of argon and the argon is encapsulated in the airtight envelope at a pressure in the range of 0.3 to 5 atmospheric pressures, the following discharge start voltage can be inhibited from lowering and thereby a discharge tube having longer lifetime can be realized.

In order to achieve the fourth object, the discharge tube according to claim 7 is characterized in that in a discharge tube where an airtight envelope is formed by hermetically sealing openings at both ends of a cylindrical case member made of an insulating material both ends of which are opened with a pair of cap members that double as a discharge electrode, a discharge gas is encapsulated in the airtight envelope, a discharge gap is formed between the discharge electrodes of the cap members disposed in the airtight envelope, and on an inner wall surface of the case member, and triggering discharge films both ends of which are disposed separated with a small discharge gap from the cap member are formed, the triggering discharge films are formed in a circumferential direction of the inner wall surface of the case member in the range of 8 to 12 at an equal interval.

In the discharge tube described in claim 7, since the triggering discharge films are formed in a circumferential direction of the inner wall surface of the case member in the range of 8 to 12 at an equal interval, the initial discharge start voltage can be inhibited from going up, and thereby a discharge tube that does not cause the initial discharge delay and is long in the lifetime can be realized.

In order to achieve the fourth object, the discharge tube according to claim 8 is characterized in that, in a discharge tube where an airtight envelope is formed by hermetically sealing openings at both ends of a case member made of an insulating material both ends of which are opened with a pair of cap members that double as a discharge electrode, a discharge gas is encapsulated in the airtight envelope, a discharge gap is formed between the discharge electrode portions of the cap members disposed in the airtight envelope, and on an inner wall surface of the case member triggering discharge films both ends of which are disposed separated by a small discharge gap from the cap member is formed, the triggering discharge films are constituted of a carbon base material of which primary raw material is carbon nanotube.

The discharge tube described in claim 8, since the triggering discharge films are constituted of a carbon base material of which primary raw material is carbon nanotube excellent in the electron emission characteristics, initial electrons can be abundantly supplied; accordingly, the initial discharge start voltage can be inhibited from going up and thereby a discharge tube that does not cause the initial discharge delay and is long in the lifetime can be realized.

Furthermore, in the triggering discharge films according to the invention, which are constituted of a carbon base material of which primary raw material is carbon nanotube, slender carbon nanotubes, being entangled with fine irregularities on the inner wall surface of the case member to be large in the adhesiveness with the inner wall surface of the case member, are hardly peeled; accordingly, the inhibition function of the initial discharge delay can be sufficiently exhibited.

In the discharge tube described in claim 8, the triggering discharge film can be constituted of a carbon base material that is obtained by impregnating a sintered body of a mixture of carbon nanotubes and amorphous carbon with silicon oil.

In order to achieve the fifth object, a discharge tube described in claim 10 is characterized in that, in a discharge tube where a plurality of discharge electrodes is disposed separated by a discharge gap, this is encapsulated in the airtight envelope together with the discharge gas and on a surface of the discharge electrode one obtained by adding potassium iodide in a binder made of a sodium silicate solution and pure water is coated to form a film containing potassium iodide, an amount of potassium iodide added to the binder is set in the range of 0.01 to 23% by weight.

In the discharge tube described in claim 10, since an amount of potassium iodide added to the binder made of a sodium silicate solution and pure water is set in the range of 0.01 to 23% by weight, fluctuations of the discharge start voltage when it is used under a high temperature environment can be suppressed within ±10% that is practically less problematic.

In the discharge tube described in claim 10, an amount of the potassium iodide added to the binder may be set in the range of 5 to 15% by weight. When an amount of the potassium iodide added to the binder is set in the range of 5 to 15% by weight, the fluctuations of the discharge start voltage can be more preferably suppressed within ±5%.

In order to achieve the sixth object, a surge absorber described in claim 12 is characterized by forming an airtight envelope by hermetically sealing openings at both ends of a case member made of an insulating material both ends of which are opened with a pair of cap members that double as a discharge electrode, encapsulating a discharge gas in the airtight envelope, forming a discharge gap between the discharge electrode portions of the cap members disposed in the airtight envelope, forming, on an inner wall surface of the case member, triggering discharge films both ends of which are disposed oppositely to the cap members separated by a small discharge gap, and further forming on a surface of the discharge electrode portion a film containing an alkali iodide.

In the surge absorber described in claim 12, since both ends of the triggering discharge film are disposed separated by a small discharge gap from the cap member that doubles as a discharge electrode, as far as the electrode material that is splashed by sputtering the discharge electrode portion does not stick to both of the small discharge gaps disposed on both ends of the triggering discharge film, the insulation deterioration is not caused. Accordingly, the surge absorber according to the invention, in comparison with an existing surge absorber 60 formed by oppositely disposing a pair of triggering discharge films 78, 78 separated by a small discharge gap 76, can suppress the insulation deterioration from occurring, and thereby the lifetime of the surge absorber can be made longer.

In the surge absorber described in claim 12, since the triggering discharge film is not electrically connected with the cap member that doubles as a discharge electrode, an amount of electrons emitted in the small discharge gap is suppressed. However, since a film containing an alkali iodide that is small in the work function and excellent in the electron emission characteristics is formed on a surface of the discharge electrode portion, high responsiveness is secured as well.

In the surge absorber described in claim 12, as the alkali iodide, for instance, a simple substance of potassium iodide (KI), sodium iodide (NaI), cesium iodide (CsI) and rubidium iodide (RbI) or a mixture thereof can be cited.

### BRIEF DESCRIPTION OF THE DRAWINGS

FIG. 1 is a sectional view showing a first discharge tube according to the invention.

FIG. 2 is a graph showing relationship between the number of discharges and the discharge start voltage in the first discharge tube according to the invention and an existing discharge tube.

FIG. 3 is a graph showing relationship between the number of discharges and the discharge start voltage in the first discharge tube according to the invention and an existing discharge tube.

FIG. 4 is a graph showing relationship between the number of discharges and the discharge start voltage in the first discharge tube according to the invention and an existing discharge tube.

FIG. 5 is a graph showing relationship between the number of discharges and the discharge start voltage in the first discharge tube according to the invention and an existing discharge tube.

FIG. 6 is a sectional view showing a second discharge tube according to the invention.

FIG. 7 is a sectional view showing a third discharge tube according to the invention.

FIG. 8 is a chart showing a transition of the direct current discharge start voltage when a third discharge tube according to the invention, in which a discharge gas made of argon is encapsulated in an airtight envelope at two atmospheric pressures, is operated at an interval of 100 ms.

FIG. 9 is a chart showing a transition of the direct current discharge start voltage when a discharge tube in which a discharge gas made of argon is encapsulated in the airtight envelope at six atmospheric pressures, is operated at an interval of 100 ms.

FIG. 10 is a graph showing relationship between the number of discharges and the following discharge start voltage in a third discharge tube according to the invention, in which a discharge gas made of argon is encapsulated at two atmospheric pressures in an airtight envelope, and a discharge tube in which a mixture gas made of argon, neon and H₂ is encapsulated in an airtight envelope at two atmospheric pressures.

FIG. 11 is a sectional view showing a fourth discharge tube according to the invention.

FIG. 12 is a B-B sectional view of FIG. 11.

FIG. 13 is a graph showing relationship between the number of discharges and the initial discharge start voltage and relationship between the number of discharges and the following discharge start voltage in a fourth discharge tube according to the invention, in which eight triggering discharge films are formed.

FIG. 14 is a graph showing relationship between the number of discharges and the initial discharge start voltage and relationship between the number of discharges and the following discharge start voltage in the fourth discharge tube according to the invention, in which ten triggering discharge films are formed.

FIG. 15 is a graph showing relationship between the number of discharges and the initial discharge start voltage and relationship between the number of discharges and the following discharge start voltage in the fourth discharge tube according to the invention, in which twelve triggering discharge films are formed.

FIG. 16 is a graph showing relationship between the number of discharges and the initial discharge start voltage and relationship between the number of discharges and the following discharge start voltage in a discharge tube in which four triggering discharge films are formed.

FIG. 17 is a graph showing relationship between the number of discharges and the initial discharge start voltage and relationship between the number of discharges and the following discharge start voltage in a discharge tube in which six triggering discharge films are formed.

FIG. 18 is a graph showing relationship between the number of discharges and the initial discharge start voltage and relationship between the number of discharges and the following discharge start voltage in a discharge tube in which fourteen triggering discharge films are formed.

FIG. 19 is a sectional diagram showing a fifth discharge tube according to the invention.

FIG. 20 is a graph showing relationship between the number of discharges and the initial discharge start voltage in a fifth discharge tube according to the invention, in which a triggering discharge film is constituted of a carbon base material obtained by impregnating a sintered body of a mixture of carbon nanotube and amorphous carbon with silicone oil, and a discharge tube in which a triggering discharge film is constituted of a carbon base material of which primary raw material is graphite.

FIG. 21 is a sectional view showing a sixth discharge tube according to the invention.

FIG. 22 is a C-C sectional view of FIG. 21.

FIG. 23 is a graph showing relationship between an amount of potassium iodide (KI) added to a binder and the fluctuations of the direct current discharge start voltage.

FIG. 24 is a sectional view showing a surge absorber according to the invention.

FIG. 25 is a graph showing relationship between a ratio of potassium iodide compounded and the direct current discharge start voltage.

FIG. 26 is a graph showing relationship between a ratio of potassium iodide compounded and the impulse discharge start voltage.

FIG. 27 is a sectional view showing an existing discharge tube (surge absorber).

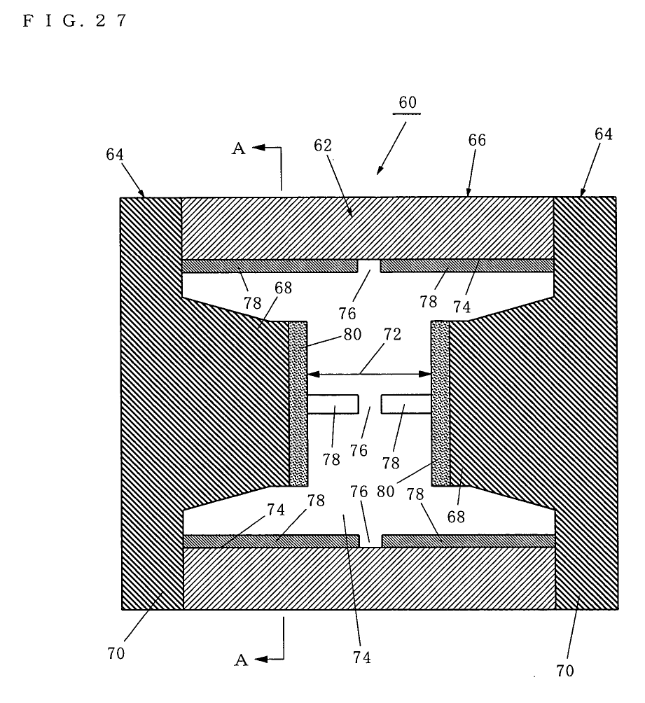

FIG. 28 is an A-A sectional view of FIG. 27.

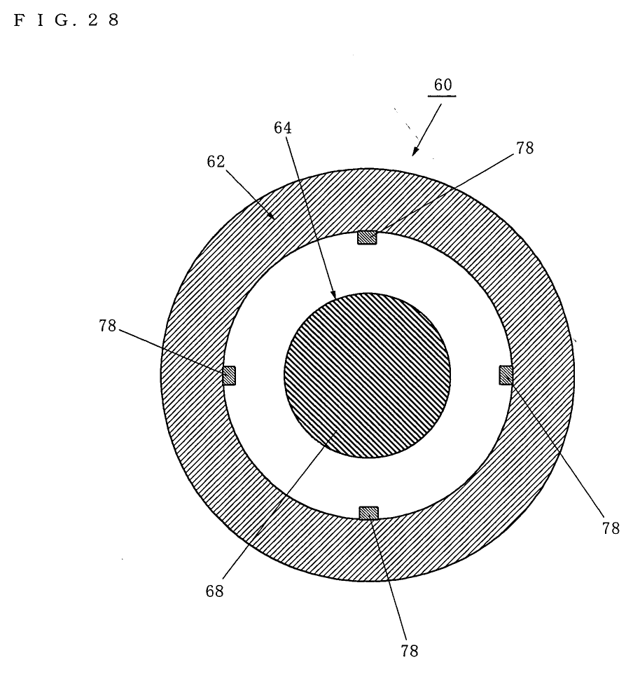

### BEST MODE FOR CARRYING OUT THE INVENTION

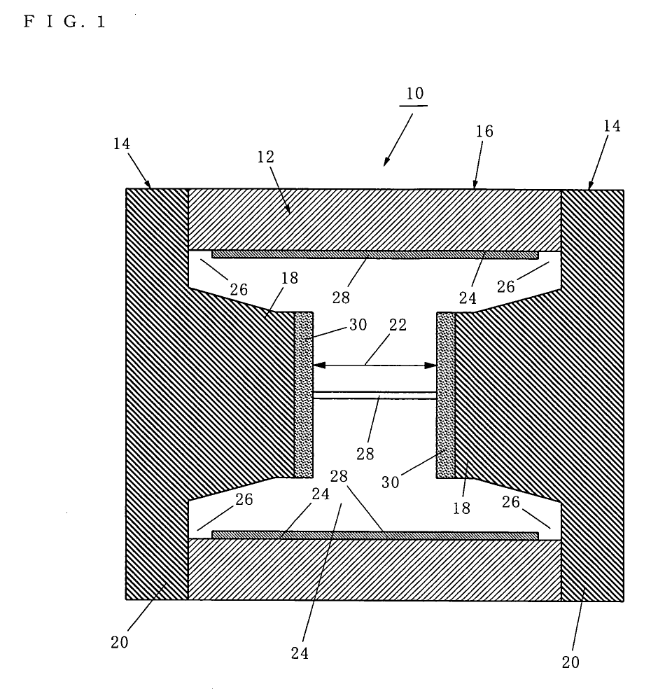

FIG. 1 shows a first discharge tube 10 according to the invention. The first discharge tube 10 corresponds to claims 1 through 4.

The first discharge tube 10 according to the invention, as shown in FIG. 1, is constituted by forming an airtight envelope 16 by hermetically clogging openings at both ends of a cylindrical case member 12 that is made of an insulating material such as ceramics, of which both ends are opened, with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed.

Furthermore, on an inner wall surface 24 of the case member 12, a plurality of linear triggering discharge films 28 both ends of which are disposed opposite to the cap members 14, 14 that double as a discharge electrode separated by a small discharge gap 26 is formed. The triggering discharge film 28 is constituted of an electrically conductive material such as a carbon base material.

On a surface of the discharge electrode portion 18, an insulating film 30 that contains an alkali iodide is formed. The film 30 can be formed by coating one obtained by adding a simple substance of an alkali iodide such as potassium iodide (KI), sodium iodide (NaI), cesium iodide (CsI) and rubidium iodide (RbI) or a mixture thereof in a binder made of a sodium silicate solution and pure water on a surface of the discharge electrode portion 18.

In this case, the simple substance of an alkali iodide or a mixture thereof is mixed at a ratio in the range of 0.01 to 70% by weight and the binder is mixed at a ratio in the range of 99.99 to 30% by weight. Furthermore, mixing ratios of the sodium silicate solution and pure water in the binder are in the range of 0.01 to 70% by weight for the sodium silicate solution and in the range of 99.99 to 30% by weight for the pure water.

Furthermore, when at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the first discharge tube 10 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added in the film 30 together with the bromide or without the bromide, the discharge start voltage of the first discharge tube 10 can be stabilized.

These substances are added at a compounding ratio in the range of 0.01 to 10% by weight in the mixture of the simple substance of the alkali iodide or mixture thereof and the binder.

In the airtight envelope 16, a discharge gas containing Kr (krypton) that is large in the atomic weight and small in the thermal conductivity is encapsulated.

When Kr (krypton) that is large in the atomic weight and small in the thermal conductivity is contained in the discharge gas, the lifetime characteristics of the first discharge tube 10 can be improved. This is considered due to reasons below.

That is, the discharge electrode portion 18 on a negative electrode side is sputtered by an impact of positive ions always when the discharge is generated. As a result, an electrode material of the discharge electrode portion 18 on the negative electrode side is sputtered in an atomic state and adheres to the discharge electrode portion 18 and an inner wall of the airtight envelope 16 to blacken. Thereby, a surface leakage current and an inner wall potential of the airtight envelope 16 are altered to shorten the lifetime of the discharge tube.

However, since Kr is large in the atomic weight, an acceleration when Kr ions ionized during discharge generation go toward a discharge electrode portion 18 on the negative electrode side is small, that is, a shifting speed of Kr ions is slow. Accordingly, during shifting, Kr ions return to a ground state or collide with other molecules to be converted into thermal energy. It is considered that, as a result, the impact imparted on the discharge electrode portion 18 on the negative electrode side becomes smaller to suppress the discharge electrode portion 18 from being consumed owing to the sputtering.

Furthermore, since Kr is small in the thermal conductivity, when the Kr ions collide with the discharge electrode portion 18, heat is difficult to be conducted to the discharge electrode portion 18; accordingly, the discharge electrode portion 18 is melted owing to heat with difficulty. Accordingly, when a discharge gas contains Kr, at the time of discharge generation, even when the Kr ions collide with the discharge electrode portion 18, it is considered that the discharge electrode portion 18 is inhibited from causing the sputtering where the discharge electrode portion 18 is melted and sputtered.

When the discharge gas is constituted of Kr alone that is large in the atomic weight, while the long lifetime can be obtained, owing to slow shifting speed of Kr, the discharge delay is caused and the discharge characteristics deterioration are caused; accordingly, it is desirable to mix with other gas to use.

For instance, when the discharge gas is constituted of a mixture gas of Kr and H₂, owing to H₂ that is small in the atomic weight and a negative polarity gas, the discharge delay and the following current phenomenon can be effectively inhibited.

Furthermore, when the discharge gas is constituted of a mixture gas of Kr and Ar, owing to Ar small in the atomic weight, the discharge delay can be effectively inhibited. Incidentally, the mixture gas of Kr and Ar may be further mixed with H₂, in this case, owing to H₂, the responsiveness can be further improved and the following current phenomenon can be effectively inhibited.

Still furthermore, when the discharge gas is constituted of a mixture gas of Kr and Ne, owing to Ne that has a lowering operation of the discharge start voltage, the discharge generation can be readily carried out.

Furthermore, when the discharge gas is constituted of a mixture gas of Kr and H₂, a mixture gas of Kr and Ne, a mixture gas of Kr and Ar, or a mixture of three kinds of Kr, Ar and H₂, Kr is preferably mixed at a ratio in the range of 3 to 95% by volume.

That is, when a mixing ratio of Kr is less than 3% by volume, an improvement in the lifetime characteristics is not so much obtained. On the other hand, when the mixing ratio of Kr exceeds 95% by volume, the discharge characteristics largely deteriorates.

In the first discharge tube 10 according to the invention and having the foregoing configuration, when between the pair of cap portions 14, 14 that double as a discharge electrode a voltage equal to or more than the discharge start voltage of the first discharge tube 10 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge. In the first discharge tube 10 according to the invention, the creeping corona discharge that is generated at the small discharge gap 26 and is originally rapid in the speed of response is used as the trigger discharge; accordingly, high responsiveness can be realized.

The triggering discharge films 28, 28 of the first discharge tube 10 according to the invention are not electrically connected to the cap members 14, 14 that double as a discharge electrode; accordingly, an electric field is inhibited from excessively concentrating in the small discharge gap 26, resulting in obtaining a stable discharge start voltage.

That is, when, like the existing discharge tube 60, the triggering discharge films 78, 78 are electrically connected to the cap members 64, 64 that double as a discharge electrode, the electric field is excessively concentrated at the small discharge gap 76. Accordingly, although a lot of electrons are readily emitted, an amount of electrons emitted for every discharge is likely to be instable, in some cases, resulting in causing instability in the discharge start voltage.

On the other hand, in the first discharge tube 10 according to the invention, the triggering discharge films 28, 28 are not electrically connected to the cap members 14, 14 that double as a discharge electrode; accordingly, an extent of concentration of the electric field at the small discharge gap 26 is weak and an amount of emitted electrons is limited. However, an amount of electrons emitted for every discharge can be stabilized; as a result, a stable discharge start voltage can be obtained.

As mentioned above, in the first discharge tube 10 according to the invention, in the airtight envelope 16, a discharge gas containing Kr that is large in the atomic weight and small in the thermal conductivity is encapsulated. Accordingly, the discharge electrode portion 18 can be inhibited from consuming owing to the sputtering, and thereby, in comparison with an existing discharge tube 60, the lifetime characteristics can be improved.

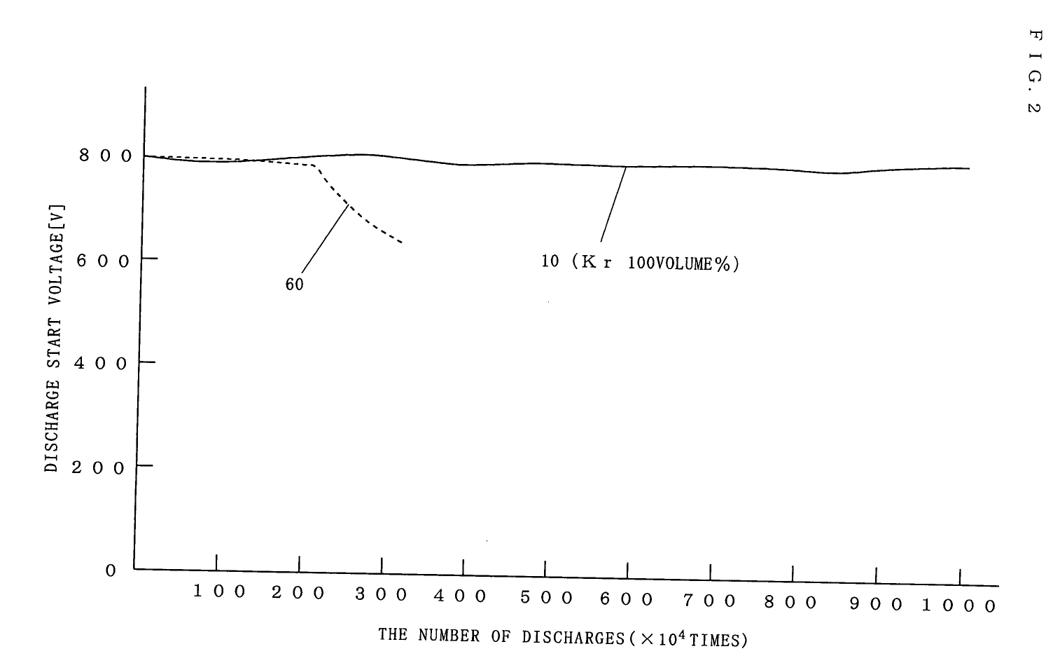

The inventors, as shown in FIGS. 2 through 5, experimentally investigated relationship between the number of discharges and the discharge start voltage of the first discharge tube 10 according to the invention and existing discharge tube 60, in each of which the discharge start voltage is set at 800 V.

That is, FIG. 2 is a graph showing relationship between the number of discharges and the discharge start voltage in the first discharge tube 10 according to the invention, of which discharge gas is constituted of Kr simple substance (100% by volume) and the existing discharge tube 60 of which discharge gas is constituted of a mixture gas of Ar, Ne and H₂.

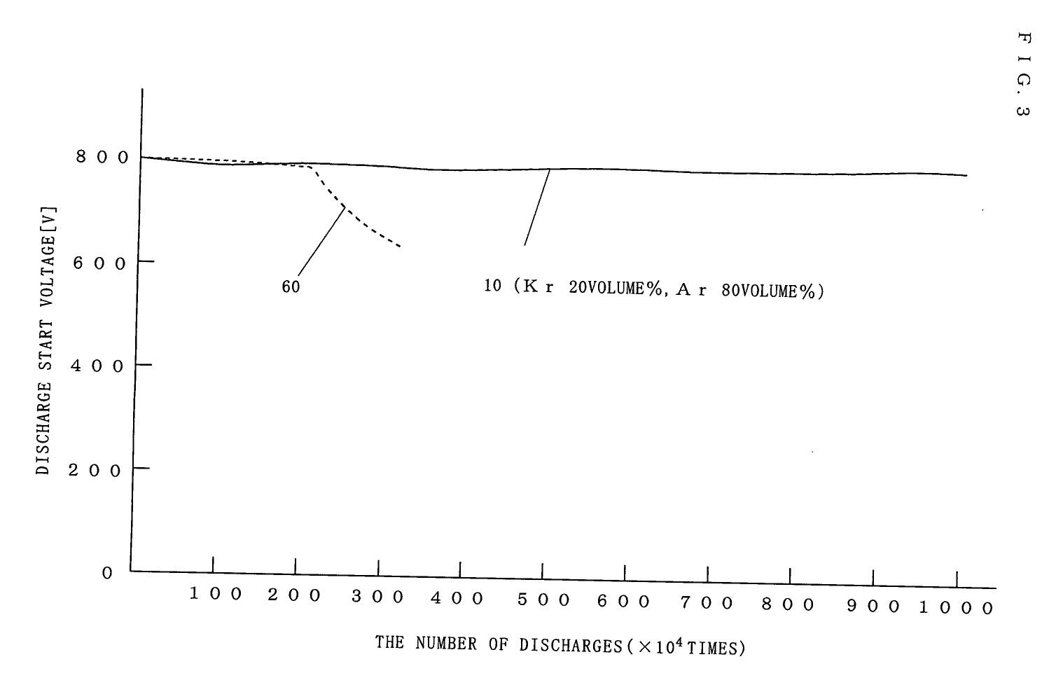

Furthermore, FIG. 3 is a graph showing relationship between the number of discharges and the discharge start voltage of the first discharge tube 10 according to the invention, of which discharge gas is constituted of a mixture gas of Kr (20% by volume) and Ar (80% by volume) and the existing discharge tube 60 of which discharge gas is constituted of a mixture gas of Ar, Ne and H₂.

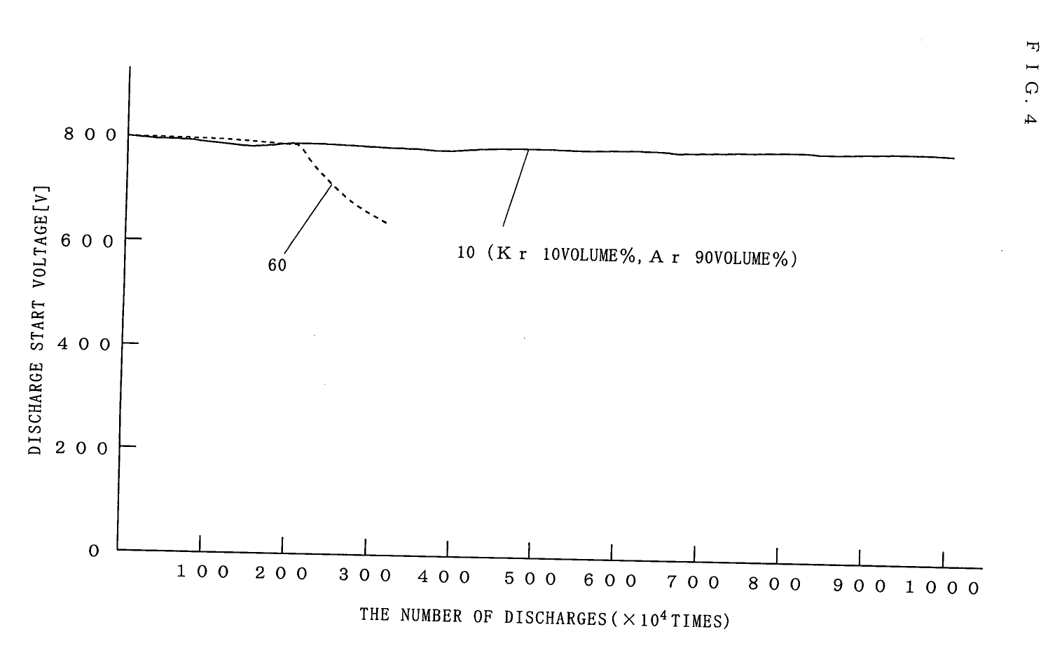

FIG. 4 is a graph showing relationship between the number of discharges and the discharge start voltage in the first discharge tube 10 according to the invention, of which discharge gas is constituted of a mixture gas of Kr (10% by volume) and Ar (90% by volume) and the existing discharge tube 60 of which discharge gas is constituted of a mixture gas of Ar, Ne and H₂.

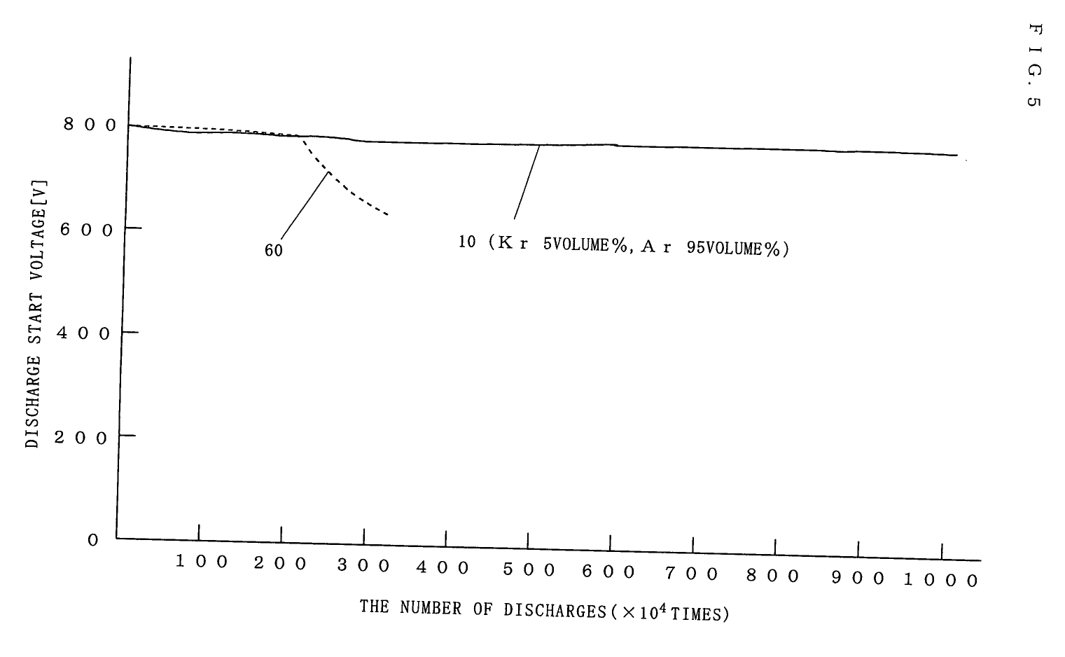

FIG. 5 is a graph showing relationship between the number of discharges and the discharge start voltage in the first discharge tube 10 according to the invention, of which discharge gas is constituted of a mixture gas of Kr (5% by volume) and Ar (95% by volume) and the existing discharge tube 60 of which discharge gas is constituted of a mixture gas of Ar, Ne and H₂.

As shown in experimental results in FIGS. 2 through 5, in the case of the existing discharge tube 60, from the vicinity where the number of discharges exceeds two million times, the discharge start voltage starts largely fluctuating to be incapable of using. On the other hand, in the case of the first discharge tube 10 according to the invention, even after the number of discharges exceeds substantially ten million times, the discharge start voltage is stable. Thus, when the discharge gas containing Kr is used, the lifetime of the first discharge tube 10 can be made longer.

Since there is no substantial difference in the lifetime characteristics between discharge tubes 10 of which ratio of Kr in the discharge gas is 100% by volume and 5% by volume, even when a ratio of Kr contained in the discharge gas is small, a sufficient improvement effect in the lifetime characteristics can be obtained.

Furthermore, in the first discharge tube 10 according to the invention, on a surface of the discharge electrode portion 18, a film 30 that contains an alkali iodide effective in stabilizing the discharge start voltage is formed. Accordingly, in the case of the first discharge tube 10 being used as a switching spark gap, even when a high voltage pulse (several hundreds Hertz or more) is supplied from a not shown capacitor, it can always stably operate at a constant discharge start voltage at such a short interval as several milliseconds.

Still furthermore, in the case of the first discharge tube 10 being used as a gas arrestor, even when a surge voltage short in the buildup time is applied, the so-called “fluctuation” of the discharge start voltage, which causes fluctuations in the discharge start voltage, is caused with difficulty; that is, it can work stably at a constant discharge start voltage.

That is, the “fluctuation” phenomenon of the discharge start voltage is a phenomenon that is caused because, when a surge voltage is applied to the first discharge tube 10, an alpha effect where initial electrons and ions that are a pilot burner of the discharge collide with discharge gas molecules to ionize these into ions and electrons and the secondary electron emission effect (gamma effect) where ionized ions collide with the film 30 on a surface of the discharge electrode portion 18 to cause to emit secondary electrons are not stably carried out.

However, in the invention, since an alkali iodide contained in the film 30 has the nature of easily ionizing the discharge gas molecules, there are a lot of ions in the airtight envelope 16. As a result, stable alpha effect and secondary electron emission effect (gamma effect) are exhibited, resulting in causing the “fluctuation” in the discharge start voltage with difficulty.

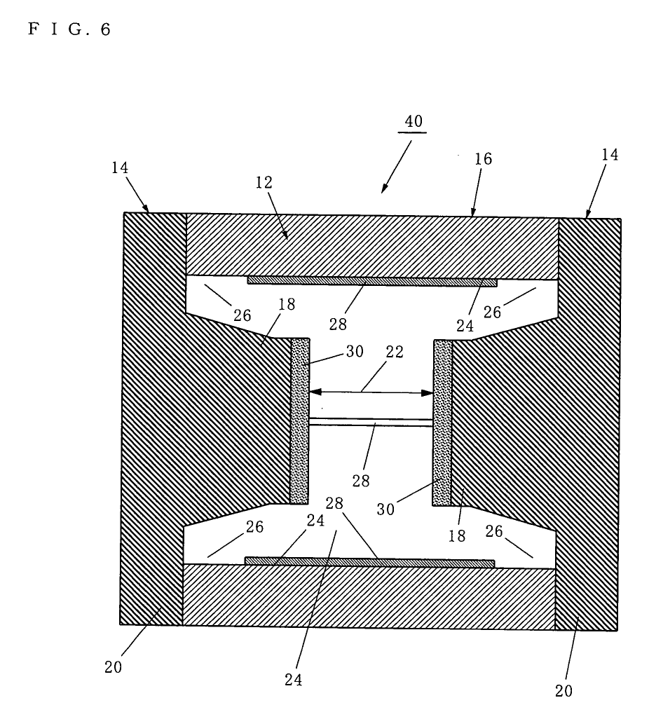

FIG. 6 shows a second discharge tube 40 according to the invention. The second discharge tube 40 corresponds to claim 5. Constituent members same as that of the first discharge tube 10 will be given the same reference numerals.

The second discharge tube 40 according to the invention is formed, as shown in FIG. 6, by forming an airtight envelope 16 by hermetically sealing openings at both ends of a cylindrical case member 12 made of ceramics as an insulating material opened at both ends thereof with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed. The end surface of the case member 12 and the connection portion 20 of the cap member 14 are hermetically sealed through a sealing member such as silver solder (not shown in the drawing).

Furthermore, on an inner wall surface 24 of the case member 12, a plurality of linear triggering discharge films 28 of which both ends are disposed opposite to the cap members 14, 14 that double as a discharge electrode separated by a small discharge gap 26 is formed. The triggering discharge film 28 is constituted of an electrically conductive material such as a carbon base material.

The cap member 14 provided with the discharge electrode portion 18 and the connection portion 20 is constituted of zirconium copper obtained by containing zirconium (Zr) in oxygen-free copper.

When the discharge electrode portion 18 is thus constituted of zirconium copper obtained by containing zirconium (Zr) in oxygen-free copper, in comparison with an existing discharge tube 60 of which discharge electrode portion 68 is constituted of oxygen-free copper, the lifetime characteristics of the second discharge tube 40 can be improved. This is due to reasons below.

That is, since the discharge electrode portion 18 on a negative electrode side is subjected to an impact of positive ions and high temperature thermal energy always when the discharge is generated, an electrode material of the discharge electrode portion 18 is melted and sputtered to cause the sputtering. As a result, the electrode material of the discharge electrode portion 18 on the negative electrode side adheres to the discharge electrode portion 18 and an inner wall of an airtight envelope 16 to blacken. Thereby, a surface leakage current and an inner wall potential of the airtight envelope 16 are altered to shorten the lifetime of the discharge tube.

However, zirconium copper obtained by containing zirconium in oxygen-free copper has a softening temperature (melting temperature) of substantially 500° C., substantially 2.5 times higher than substantially 200° C. of the softening temperature (melting temperature) of the oxygen-free copper. Accordingly, when the discharge electrode portion 18 is constituted of zirconium copper, the thermal energy resistance of the discharge electrode portion 18 is improved, the discharge electrode portion 18 is suppressed from being consumed owing to the sputtering, resulting in improving the lifetime characteristics of the second discharge tube 40. Incidentally, since zirconium has the gettering action, the gettering action contributes as well to an improvement in the discharge characteristics.

When the discharge electrode portion 18 is constituted of zirconium copper that contains zirconium in oxygen-free copper as well, similarly to the case where the discharge electrode portion 68 is constituted of existing oxygen-free copper, since impurity gases such as oxygen are not liberated during the discharge generation, a discharge gas composition in the airtight envelope 16 is not adversely affected.

Furthermore, since the thermal expansion coefficient of zirconium copper is substantially same as that of oxygen-free copper, even when the cap member 14 is constituted of zirconium copper, the connection with the case member 12 made of ceramics is not adversely affected.

On a surface of the discharge electrode portion 18, an insulating film 30 that contains an alkali iodide is formed. The film 30 can be formed by coating one obtained by adding a simple substance of an alkali iodide such as potassium iodide (KI), sodium iodide (NaI), cesium iodide (CsI) and rubidium iodide (RbI) or a mixture thereof in a binder made of a sodium silicate solution and pure water on a surface of the discharge electrode portion 18.

In this case, the simple substance of an alkali iodide or mixture thereof is mixed at a ratio in the range of 0.01 to 70% by weight and the binder is mixed at a ratio in the range of 99.99 to 30% by weight. Furthermore, mixing ratios of a sodium silicate solution and pure water in the binder are in the range of 0.01 to 70% by weight for the sodium silicate solution and in the range of 99.99 to 30% by weight for the pure water.

Furthermore, when at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the second discharge tube 40 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added in the film 30 together with the bromide or without the bromide, the discharge start voltage of the second discharge tube 40 can be stabilized.

These substances are added at a compounding ratio in the range of 0.01 to 10% by weight in the mixture of the simple substance of the alkali iodide or mixture thereof and the binder.

In the airtight envelope 16, a predetermined discharge gas is encapsulated. As the discharge gas, a simple substance of a rare gas such as argon, neon, helium and xenon or an inert gas such as nitrogen or a mixture thereof corresponds thereto. Furthermore, a mixture gas of a simple substance of a rare gas or an inert gas or a gas mixture thereof and a negative polarity gas such as H₂ corresponds thereto.

Similarly to the first discharge tube 10, when a discharge gas containing Kr (krypton) that is large in the atomic weight and small in the thermal conductivity is encapsulated in the airtight envelope 16, the lifetime characteristics of the second discharge tube 40 can be improved.

In the second discharge tube 40 having the foregoing configuration and according to the invention, when between the pair of cap members 14, 14 that double as a discharge electrode a voltage equal to or more than the discharge start voltage of the second discharge tube 40 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge. In the second discharge tube 40 according to the invention, the creeping corona discharge that is generated at the small discharge gap 26 and is originally rapid in the speed of response is used as the trigger discharge; accordingly, high responsiveness can be realized.

The triggering discharge films 28, 28 of the second discharge tube 40 according to the invention are not electrically connected to the cap members 14, 14 that double as a discharge electrode; accordingly, an electric field is inhibited from excessively concentrating in the small discharge gap 26, resulting in obtaining a stable discharge start voltage.

That is, when, like the existing discharge tube 60, the triggering discharge films 78, 78 are electrically connected to the cap members 64, 64 that double as a discharge electrode, the electric field is excessively concentrated at the small discharge gap 76. Accordingly, a lot of electrons are readily emitted; however, an amount of electrons emitted for every discharge is likely to be instable, in some cases, resulting in causing instability in the discharge start voltage.

On the other hand, in the second discharge tube 40 according to the invention, the triggering discharge films 28, 28 are not electrically connected to the cap members 14, 14 that double as a discharge electrode; accordingly, an extent of concentration of the electric field at the small discharge gap 26 is weak and an amount of emitted electrons is limited. However, an amount of electrons emitted for every discharge can be stabilized; as a result, a stable discharge start voltage can be obtained.

As mentioned above, in the second discharge tube 40 according to the invention, the discharge electrode portion 18 is made of zirconium copper obtained by containing zirconium in oxygen-free copper. The zirconium copper has a melting temperature substantially 2.5 times higher than that of the oxygen-free copper. Accordingly, in comparison with the existing discharge tube 60 of which discharge electrode portion 68 is constituted of oxygen-free copper, the thermal energy resistance of the discharge electrode portion 18 is improved. As a result, the discharge electrode portion 18 is suppressed from being consumed owing to the sputtering during the discharge generation, resulting in improving the lifetime characteristics of the second discharge tube 40.

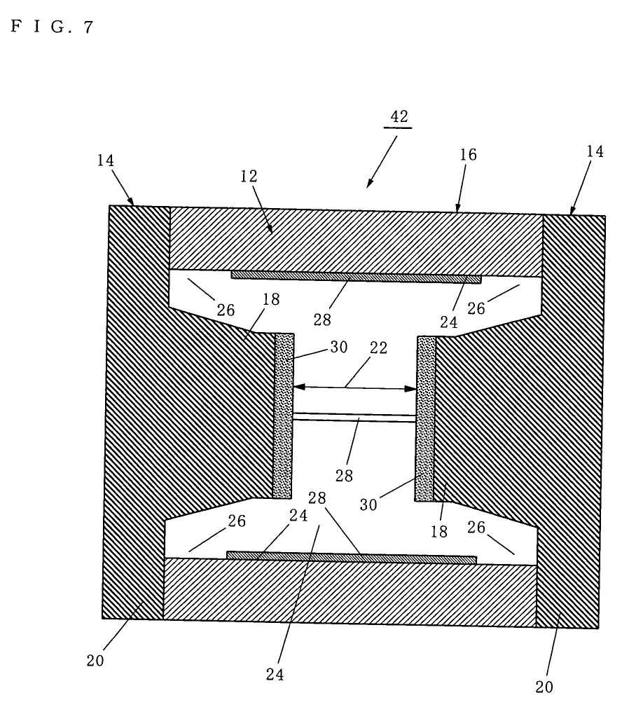

FIG. 7 shows a third discharge tube 42 according to the invention. The third discharge tube 42 corresponds to claim 6. Constituent members same as that of the first discharge tube 10 will be given the same reference numerals.

In the third discharge tube 42 according to the invention, an airtight envelope 16 is formed, as shown in FIG. 7, by hermetically sealing openings at both ends of a cylindrical case member 12 made of ceramics as an insulating material opened at both ends thereof with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed. The end surface of the case member 12 and the connection portion 20 of the cap member 14 are hermetically sealed through a sealing member such as silver solder (not shown in the drawing). The discharge gap 22 is set at, for instance, substantially 1.5 mm.

Furthermore, on an inner wall surface 24 of the case member 12, a plurality of linear triggering discharge films 28 of which both ends are disposed opposite to the cap members 14, 14 that double as a discharge electrode separated by a small discharge gap 26 is formed. The triggering discharge film 28 is constituted of an electrically conductive material such as a carbon base material.

The cap member 14 provided with the discharge electrode portion 18 and the connection portion 20 is constituted of oxygen-free copper. The discharge electrode portion 18 constituted of oxygen-free copper, not emitting impurity gases such as oxygen at the discharge generation, does not adversely affect on a discharge gas composition in the airtight envelope 16.

On a surface of the discharge electrode portion 18, an insulating film 30 that contains an alkali iodide effective in stabilizing the discharge start voltage is formed. The film 30 can be formed by coating one obtained by adding a simple substance of an alkali iodide such as potassium iodide (KI), sodium iodide (NaI), cesium iodide (CsI) and rubidium iodide (RbI) or a mixture thereof in a binder made of a sodium silicate solution and pure water on a surface of the discharge electrode portion 18.

In this case, the simple substance of an alkali iodide or a mixture thereof is mixed at a ratio in the range of 0.01 to 70% by weight and the binder is mixed at a ratio in the range of 99.99 to 30% by weight. Furthermore, mixing ratios of a sodium silicate solution and pure water in the binder are in the range of 0.01 to 70% by weight for the sodium silicate solution and in the range of 99.99 to 30% by weight for the pure water.

When at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the third discharge tube 42 can be further stabilized.

Incidentally, also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added in the film 30 together with the bromide or without the bromide, the discharge start voltage of the third discharge tube 42 can be stabilized.

These substances are added at a compounding ratio in the range of 0.01 to 10% by weight in the mixture of the simple substance of the alkali iodide or mixture thereof and the binder.

The insulating film 30 that contains an alkali iodide, being small in the work function and excellent in the electron emission characteristics, works so as to lower the discharge start voltage. In particular, when one in which potassium iodide (KI) is added to a binder made of a sodium silicate solution and pure water is coated to form the film 30, the discharge start voltage can be remarkably lowered.

In this case, when a compounding ratio of potassium iodide added to the binder (a compounding ratio of the sodium silicate solution and pure water is 1:1) exceeds 40% by weight, potassium iodide saturates in the solubility to the binder and is not dissolved further. Accordingly, a compounding ratio of potassium iodide is preferably in the range of 0.1 to 40% by weight, and when the compounding ratio of potassium iodide is 40% by weight, the discharge start voltage is most largely lowered.

In the airtight envelope 16, a discharge gas made of argon is encapsulated at a pressure in the range of 0.3 to 5 atmospheric pressures.

By thus encapsulating a discharge gas made of argon at a pressure in the range of 0.3 to 5 atmospheric pressures in the airtight envelope 16, when the third discharge tube 42 according to the invention is repeatedly operated at a constant time interval, the second discharge start voltage and subsequent thereto (following discharge start voltages) after the first discharge start voltage (initial discharge start voltage) can be inhibited from lowering.

The reason for argon being encapsulated in the airtight envelope 16 being set at a pressure in the range of 0.3 to 5 atmospheric pressures is as follows. That is, when a pressure of the encapsulated gas is lower than 0.3 atmospheric pressures, since an amount of gas molecules in the airtight envelope 16 is scanty, at the time of discharge generation, positive ions, without colliding with gas molecules, collide at a higher ratio with the discharge electrode portion 18 on the negative electrode side, resulting in an increase in an amount of sputtering of the discharge electrode portion 18 on the negative electrode side. The electrode material of the discharge electrode portion 18 on the sputtered negative electrode side is sputtered in an atomic state and, while absorbing gas molecules, adheres to an inner wall of the airtight envelope 16. Thereby, a discharge gas composition in the airtight envelope 16 is altered, resulting in causing the instability in the discharge start voltage.

On the other hand, when a pressure of encapsulated gas is higher than 5 atmospheric pressures, between portions where an electric field of the discharge electrode portions 18, 18 is likely to be concentrated, in some cases a local discharge is generated at a lower voltage to cause the instability of the discharge start voltage.

Accordingly, a gas pressure at which argon is encapsulated is, as mentioned above, set preferably in the range of 0.3 to 5 atmospheric pressures.

In the third discharge tube 42 according to the invention, when between the pair of cap members 14, 14 that double as a discharge electrode a voltage equal to or more than the discharge start voltage of the third discharge tube 42 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge. In the third discharge tube 42 according to the invention, the creeping corona discharge that is generated at the small discharge gap 26 and is rapid originally in the speed of response is used as the trigger discharge; accordingly, high responsiveness can be realized.

Since both ends of each of the triggering discharge films 28 of the third discharge tube 42 according to the invention are disposed separated by a small discharge gap 26 from the cap members 14, 14 that double as a discharge electrode, as far as the electrode material that is splashed by sputtering the discharge electrode portion 18 does not stick to both of the small discharge gaps 26 disposed at both ends of the triggering discharge film 28, the insulation deterioration is not caused. Accordingly, the third discharge tube 42 according to the invention, in comparison with an existing discharge tube 60 formed by oppositely disposing a pair of triggering discharge films 78, 78 separated by a small discharge gap 76, can suppress the insulation deterioration from occurring.

In this case, since the triggering discharge film 28 is not electrically connected to the cap members 14, 14 that double as a discharge electrode, an amount of electrons emitted in the small discharge gap 26 is suppressed. However, since a film 30 containing an alkali iodide that is small in the work function and excellent in the electron emission characteristics is formed on a surface of the discharge electrode portion 18, high responsiveness is also secured.

As mentioned above, in the third discharge tube 42 according to the invention, since the discharge gas made of argon is encapsulated at a pressure in the range of 0.3 to 5 atmospheric pressures in the airtight envelope 16, the following discharge start voltage is not caused to decrease, resulting in realizing a discharge tube long in the lifetime.

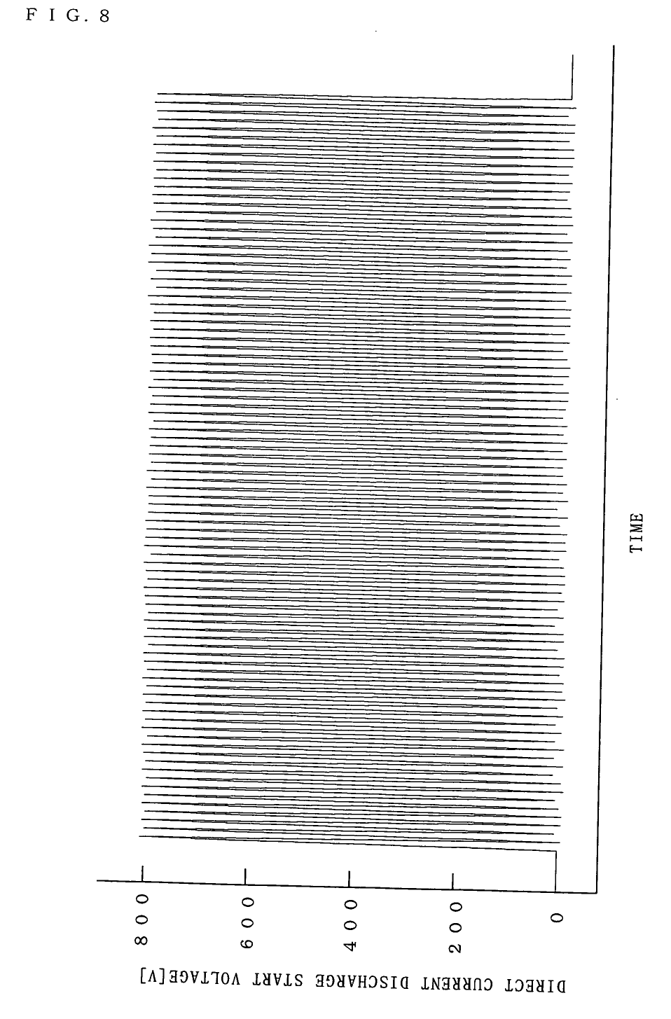

FIG. 8 is a chart showing a transition of the direct current discharge start voltage when the third discharge tube 42 according to the invention, in which a discharge gas made of argon is encapsulated in the airtight envelope 16 at two atmospheric pressures and of which direct current discharge start voltage is set at 800 V, is operated at an interval of 100 ms. As obvious from the chart, it is found that, in the third discharge tube 42, the following discharge start voltage is stable always at substantially 800 V that is a rating.

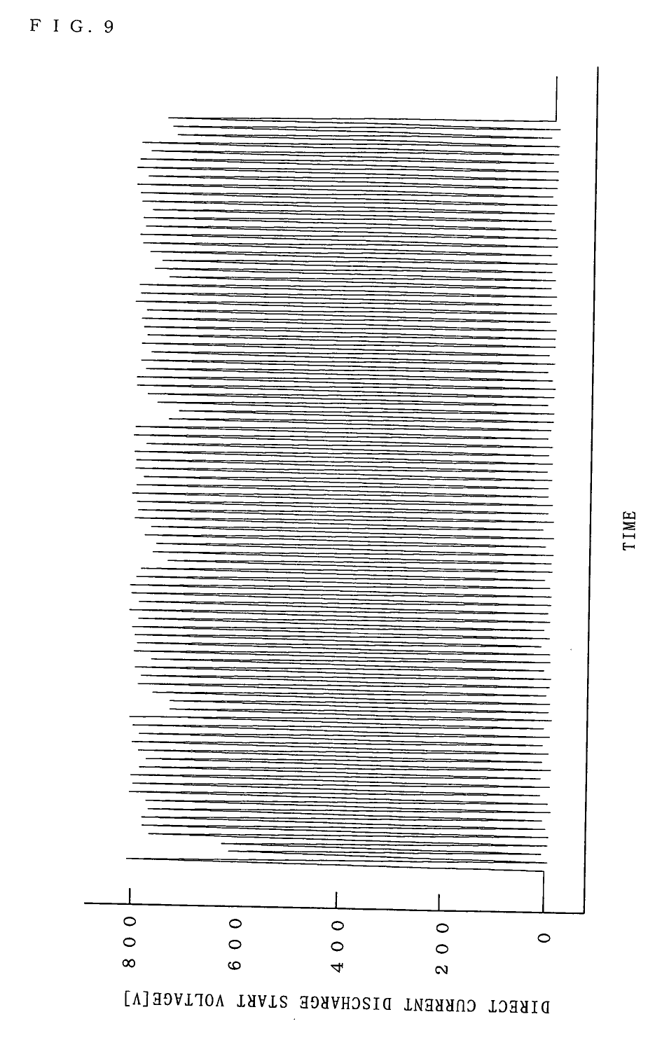

On the other hand, FIG. 9 is a chart showing a transition of a direct current discharge start voltage when a discharge tube in which a discharge gas made of argon is encapsulated in the airtight envelope 16 at six atmospheric pressures and of which direct current discharge start voltage is set at 800 V, is operated at an interval of 100 ms. As is shown in the chart, in the case of the discharge tube, the following discharge start voltage frequently becomes lower than 800 V that is a rating; that is, the operation of the discharge tube is very instable.

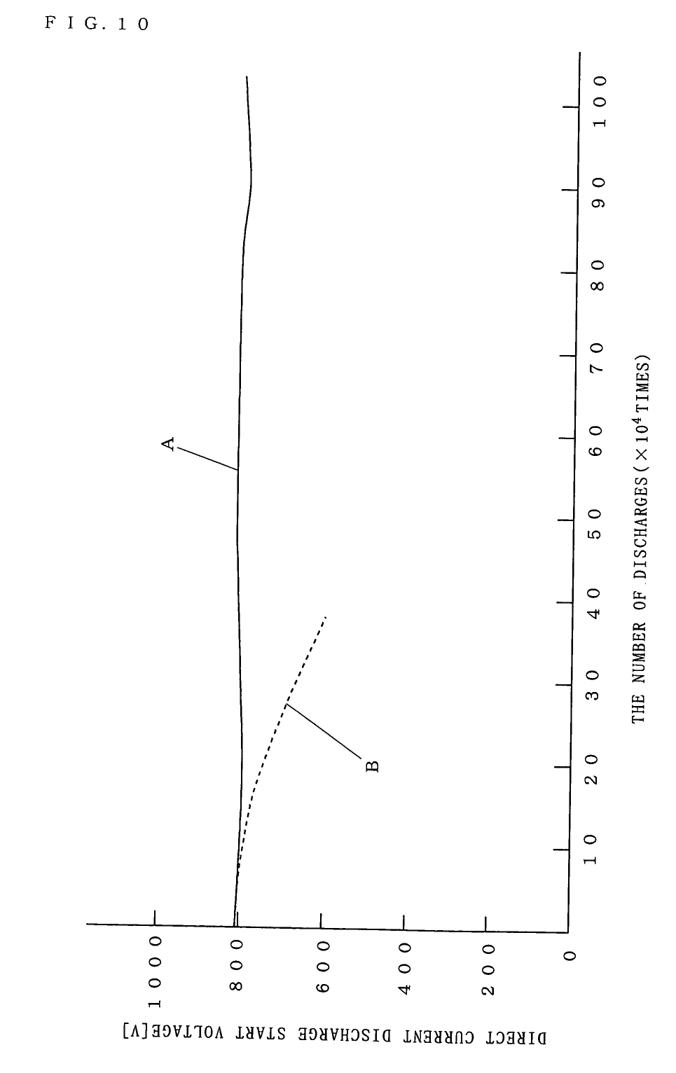

Furthermore, FIG. 10 is a graph showing relationship between the number of discharges and the following discharge start voltage in the third discharge tube 42 according to the invention, in which a discharge gas made of argon is encapsulated at two atmospheric pressures in the airtight envelope and a discharge tube in which a mixture gas made of argon (40%), neon (40%) and H₂ (20%) is encapsulated in the airtight envelope 16 at two atmospheric pressures. As shown in the graph, in the case of the discharge tube in which a mixture gas made of argon, neon and H₂ is encapsulated in the airtight envelope 16 (graph B in FIG. 10), before the number of discharges reaches 400 thousands times, the following discharge start voltage decreases to be incapable of using. On the other hand, in the case of the third discharge tube 42 according to the invention (graph A in FIG. 10), even when the number of discharges exceeds one million times, the following discharge start voltage does not exhibit such a large change; that is, the longer lifetime can be realized.

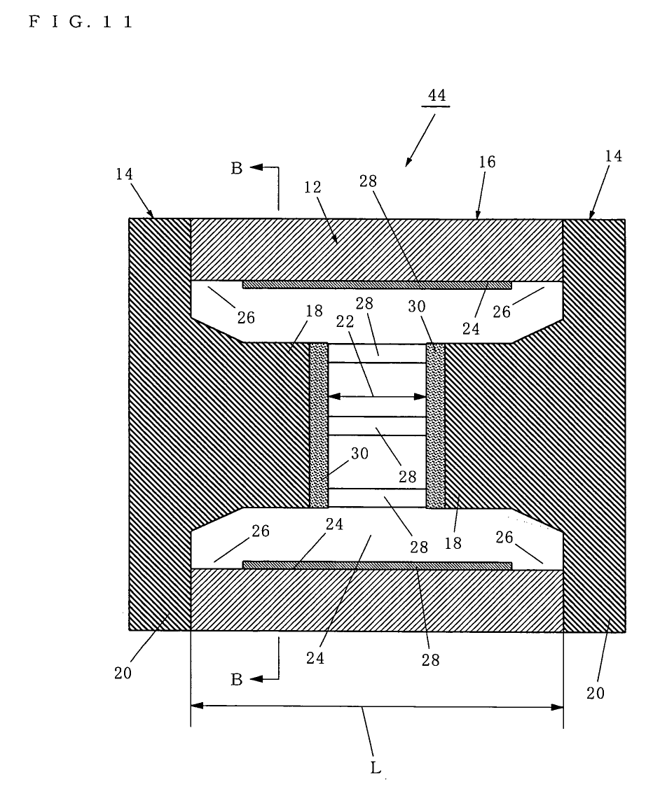

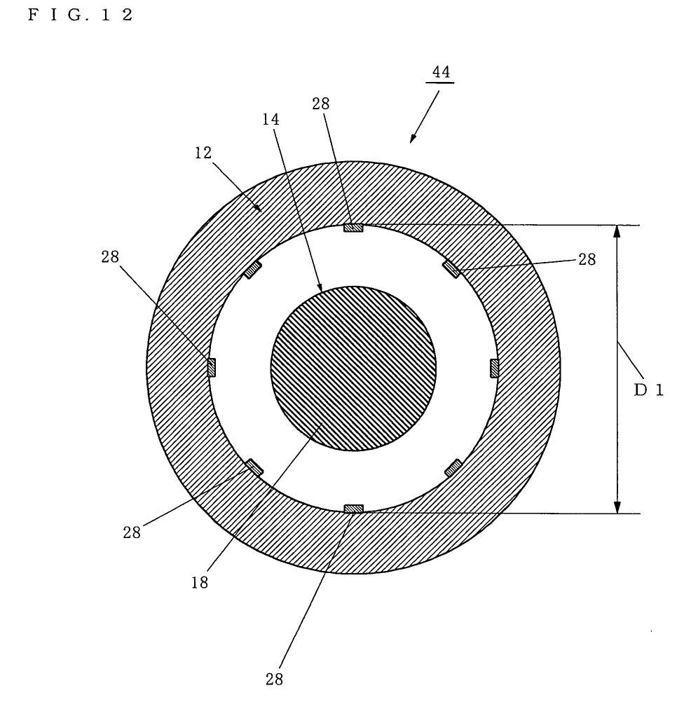

FIGS. 11 and 12 show a fourth discharge tube 44 according to the invention. The fourth discharge tube 44 corresponds to claim 7. Constituent members same as that of the first discharge tube 10 will be given the same reference numerals.

The fourth discharge tube 44 according to the invention is formed by forming an airtight envelope 16, as shown in FIGS. 11 and 12, by hermetically sealing openings at both ends of a cylindrical case member 12 made of ceramics as an insulating material opened at both ends with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed. The discharge gap 22 is set at, for instance, substantially 1.5 mm.

The cap member 14 provided with the discharge electrode portion 18 and the connection portion 20 is constituted of oxygen-free copper or zirconium copper obtained by containing zirconium (Zr) in oxygen-free copper. The end surface of the case member 12 and the connection portion 20 of the cap member 14 are hermetically sealed through a sealing member such as silver solder (not shown in the drawing).

Furthermore, on an inner wall surface 24 of the case member 12, a plurality of linear triggering discharge films 28 of which both ends are disposed opposite to the cap members 14, 14 that double as a discharge electrode separated by a small discharge gap 26 is formed. In FIGS. 11 and 12, eight of the triggering discharge films 28 are formed in a circumferential direction of the inner wall surface 24 of the case member 12 at an interval of 45°. However, this is only an example and the triggering discharge films 28 can be formed at the number in the range of 8 to 12 in a circumferential direction of the inner wall surface 24 of the case member 12 at an equal interval.

The triggering discharge film 28 is constituted of an electrically conductive material such as a carbon base material. The triggering discharge film 28 can be formed by rubbing a core material made of, for instance, a carbon base material.

Incidentally, when a total length L (FIG. 11) of the case member 12 is 4.6 mm and an inner diameter D1 thereof (FIG. 12) is 6 mm, a length of the triggering discharge film 28 is set at 3 mm and a width thereof is set at 0.57 mm.

On a surface of the discharge electrode portion 18, an insulating film 30 that contains an alkali iodide effective in stabilizing the discharge start voltage is formed. The film 30 can be formed by coating one obtained by adding a simple substance of an alkali iodide such as potassium iodide (KI), sodium iodide (NaI), cesium iodide (CsI) and rubidium iodide (RbI) or a mixture thereof in a binder made of a sodium silicate solution and pure water on a surface of the discharge electrode portion 18.

In this case, the simple substance of an alkali iodide or a mixture thereof is mixed at a ratio in the range of 0.01 to 70% by weight and the binder is mixed at a ratio in the range of 99.99 to 30% by weight. Furthermore, mixing ratios of a sodium silicate solution and pure water in the binder are in the range of 0.01 to 70% by weight for the sodium silicate solution and in the range of 99.99 to 30% by weight for the pure water.

When at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the fourth discharge tube 44 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆₀₁₁) and potassium titanate (K₂Ti₄O₉) is added in the film 30 together with the bromide or without the bromide, the discharge start voltage of the fourth discharge tube 44 can be stabilized.

These substances are added at a compounding ratio in the range of 0.01 to 10% by weight in the mixture of the simple substance of the alkali iodide or mixture thereof and the binder.

The insulating film 30 that contains an alkali iodide, being small in the work function and excellent in the electron emission characteristics, works so as to lower the discharge start voltage. In particular, when one in which potassium iodide (KI) is added to a binder made of a sodium silicate solution and pure water is coated to form the film 30, the discharge start voltage can be remarkably lowered.

In this case, when a compounding ratio of potassium iodide added to the binder (a compounding ratio of the sodium silicate solution and pure water is 1:1) exceeds 40% by weight, potassium iodide saturates in the solubility to the binder and is not dissolved further. Accordingly, a compounding ratio of potassium iodide is preferably in the range of 0.1 to 40% by weight, and when the compounding ratio of potassium iodide is 40% by weight, the discharge start voltage is most largely lowered.

In the airtight envelope 16, a predetermined discharge gas is encapsulated. As the discharge gas, for instance, a simple substance of rare gases such as argon, neon, helium and xenon or inert gases such as nitrogen or a mixture thereof corresponds thereto. Furthermore, a mixture gas of a simple substance of rare gases or inert gases or a gas mixture thereof and a negative polarity gas such as H₂ corresponds thereto.

In the fourth discharge tube 44 according to the invention, when between the pair of cap members 14, 14 that double as a discharge electrode a voltage equal to or more than the discharge start voltage of the fourth discharge tube 44 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge.

Thus, in the fourth discharge tube 44 according to the invention, the triggering discharge films 28 are disposed in the range of 8 to 12 at an equal interval in a circumferential direction of the inner wall surface 24 of the case member 12; accordingly, the initial discharge start voltage can be inhibited from going up and thereby a discharge tube that does not cause the initial discharge delay and is long in the lifetime can be realized. When a discharge tube is repeatedly operated, a discharge start voltage at the first time is called an initial discharge start voltage and a second and on discharge start voltages subsequent to the initial discharge start voltage is called a following discharge start voltage.

That is, when the triggering discharge films 28 are formed in the number of 7 or less on the inner wall surface 24 of the case member 12, an amount of initial electrons supplied is deficient and the initial discharge delay cannot be sufficiently inhibited.

On the other hand, when the triggering discharge films 28 are formed at the number of 13 or more on the inner wall surface 24 of the case member 12, the initial discharge start voltage can be inhibited from going up. However, the trigger discharge does not shift to a primary discharge between the discharge electrode portions 18, 18, namely, the discharge is maintained at the triggering discharge film 28, resulting in causing a problem in that the following discharge start voltage decreases.

Accordingly, the triggering discharge films 28 are preferably formed in the range of 8 to 12 at an equal interval in a circumferential direction of the inner wall surface 24 of the case member 12.

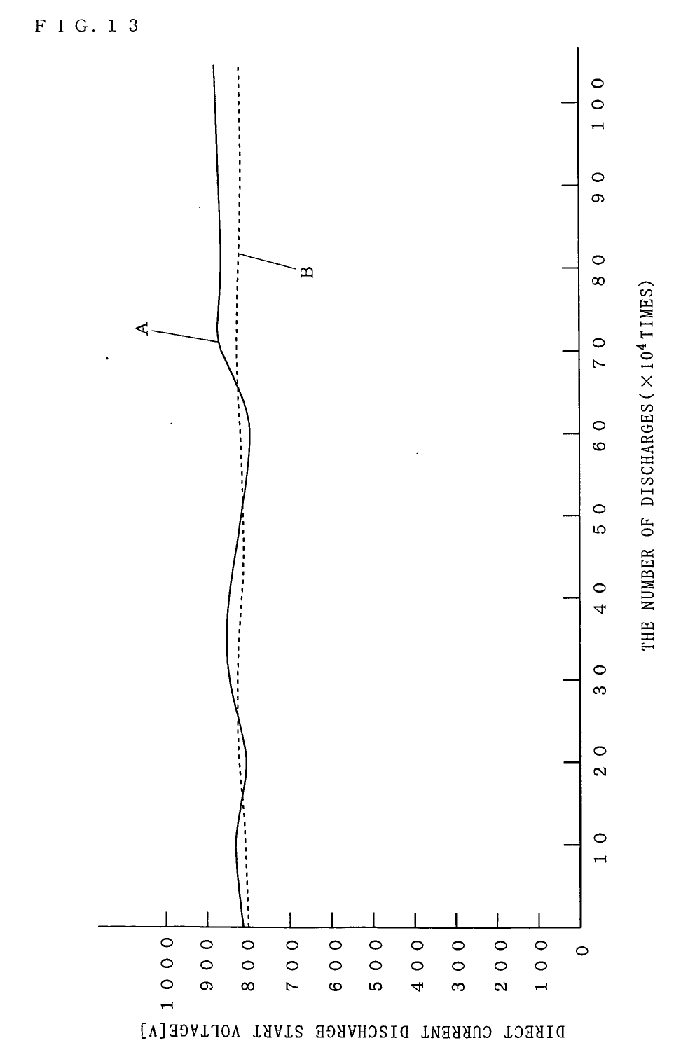

FIGS. 13 through 15 are graphs each of which shows relationship between the number of discharges and the initial discharge start voltage and relationship between the number of discharges and the following discharge start voltage of the fourth discharge tube 44 according to the invention, of which direct current discharge start voltage is set at 800 V.

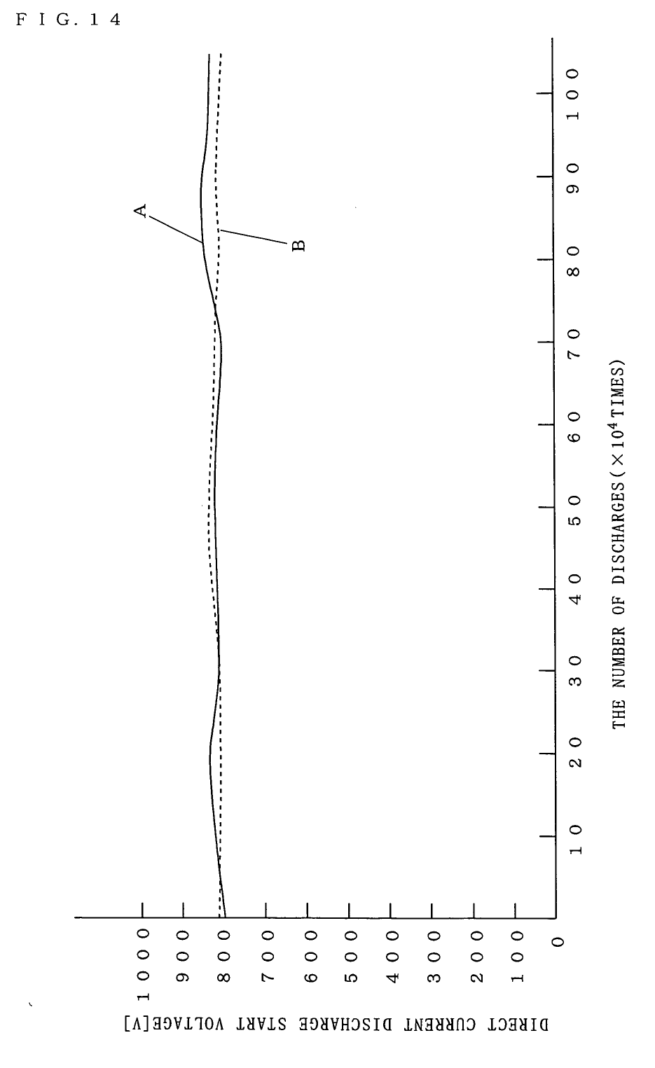

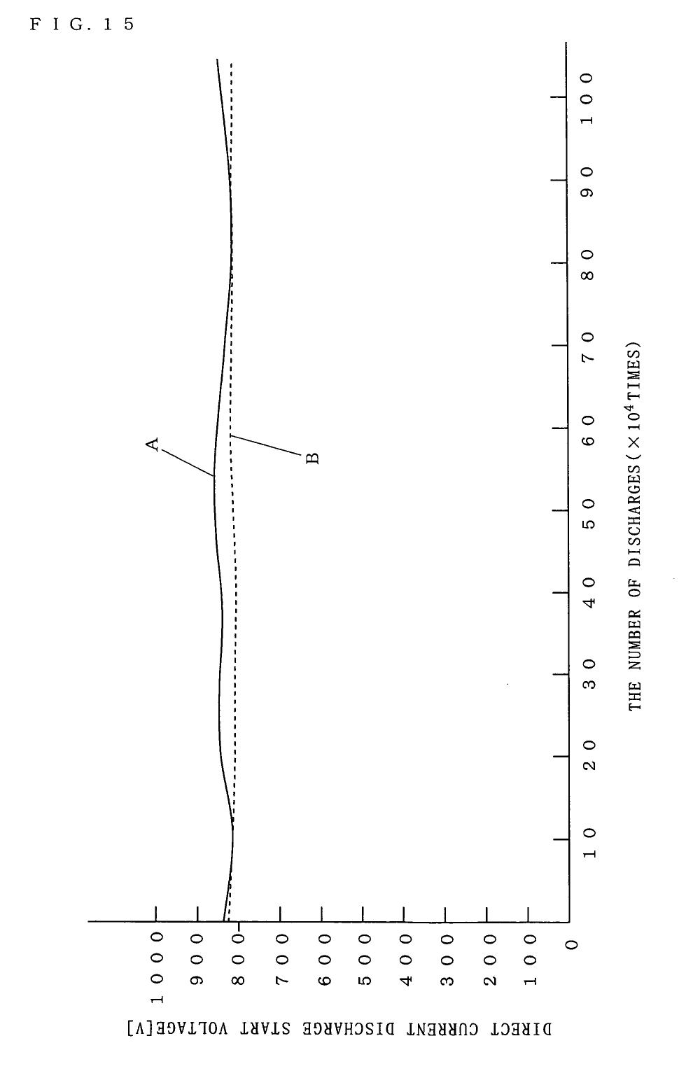

That is, FIG. 13 is a graph showing relationship between the number of discharges and the initial discharge start voltage (A of FIG. 13) and relationship between the number of discharges and the following discharge start voltage (B of FIG. 13) of the fourth discharge tube 44 according to the invention, in which the triggering discharge films 28 are disposed by 8 at an interval of 45° in a circumferential direction of the inner wall surface 24 of the case member 12. Furthermore, FIG. 14 is a graph showing relationship between the number of discharges and the initial discharge start voltage (A of FIG. 14) and relationship between the number of discharges and the following discharge start voltage (B of FIG. 14) of the fourth discharge tube 44 according to the invention, in which the triggering discharge films 28 are disposed by 10 at an interval of 36° in a circumferential direction of the inner wall surface 24 of the case member 12. Still furthermore, FIG. 15 is a graph showing relationship between the number of discharges and the initial discharge start voltage (A of FIG. 15) and relationship between the number of discharges and the following discharge start voltage (B of FIG. 15) of the fourth discharge tube 44 according to the invention, in which the triggering discharge films 28 are disposed by 12 at an interval of 30° in a circumferential direction of the inner wall surface 24 of the case member 12.

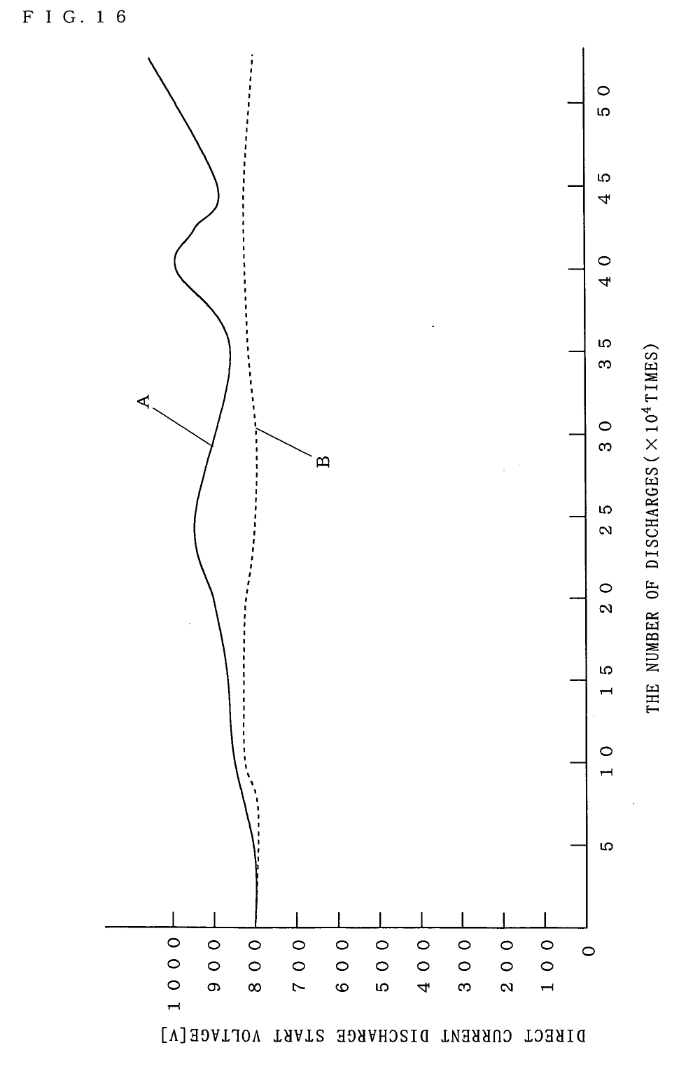

On the other hand, FIGS. 16 through 18 are graphs each of which shows relationship between the number of discharges and the initial discharge start voltage and relationship between the number of discharges and the following discharge start voltage of a discharge tube as a comparative example of the fourth discharge tube 44 according to the invention.

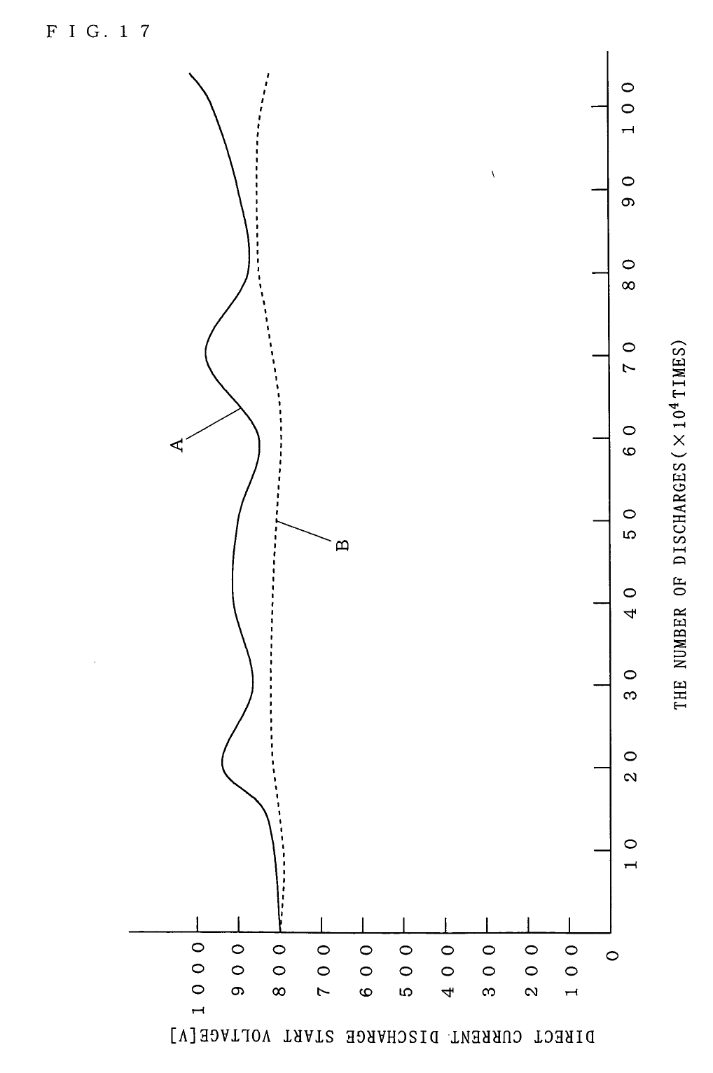

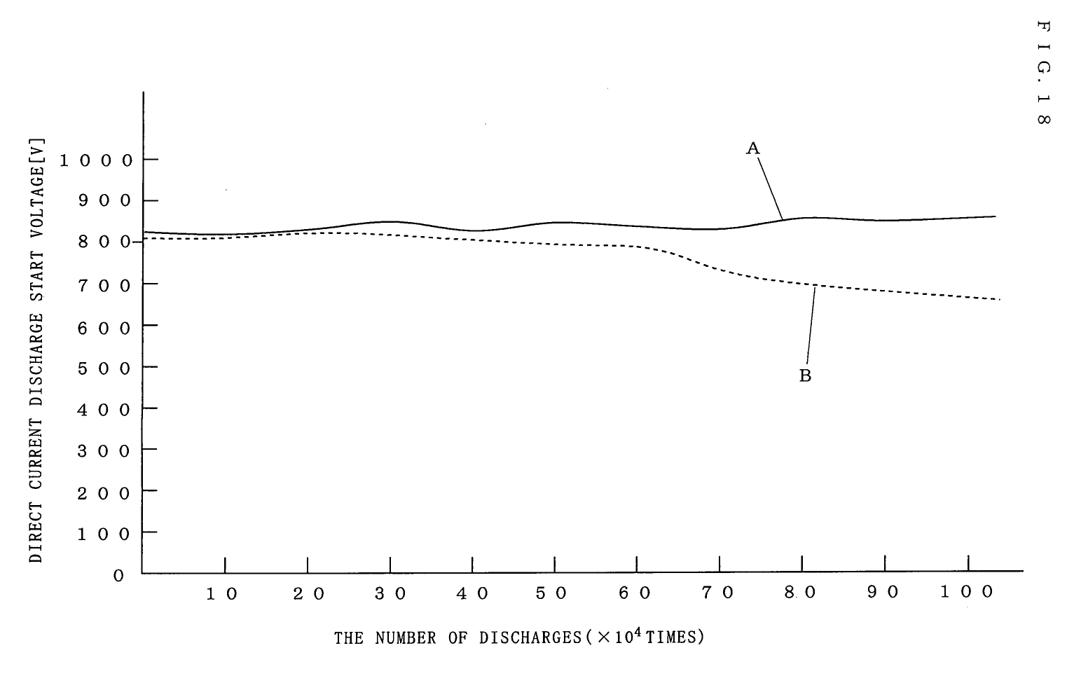

That is, FIG. 16 is a graph showing relationship between the number of discharges and the initial discharge start voltage (A of FIG. 16) and relationship between the number of discharges and the following discharge start voltage (B of FIG. 16) of a discharge tube as a comparative example in which the triggering discharge films 28 are disposed by 4 at an interval of 90° in a circumferential direction of the inner wall surface 24 of the case member 12. Furthermore, FIG. 17 is a graph showing relationship between the number of discharges and the initial discharge start voltage (A of FIG. 17) and relationship between the number of discharges and the following discharge start voltage (B of FIG. 17) of a discharge tube as a comparative example in which the triggering discharge films 28 are disposed by 6 at an interval of 60° in a circumferential direction of the inner wall surface 24 of the case member 12. Still furthermore, FIG. 18 is a graph showing relationship between the number of discharges and the initial discharge start voltage (A of FIG. 18) and relationship between the number of discharges and the following discharge start voltage (B of FIG. 18) of a discharge tube as a comparative example in which the triggering discharge films 28 are disposed by 14 at an interval of substantially 26° in a circumferential direction of the inner wall surface 24 of the case member 12.

As shown in FIGS. 13 through 15, in the case of the fourth discharge tubes 44 according to the invention, which, respectively, has 8 (FIG. 13), 10 (FIG. 14) and 12 (FIG. 15) triggering discharge films 28 at an equal interval in a circumferential direction of the inner wall surface 24 of the case member 12, even when the number of discharges exceeds one million times, the initial discharge start voltage does not exhibit such a large change; that is, without causing the initial discharge delay, longer lifetime is realized. Furthermore, in the case of the fourth discharge tubes 44 according to the invention, which are shown in FIGS. 13 through 15, the following discharge start voltages are stable as well.

On the other hand, as shown in FIGS. 16 and 17, in the case of discharge tubes according to the comparative examples, in which, respectively, 4 (FIG. 16) and 6 (FIG. 17) triggering discharge films 28 are disposed at an equal interval in a circumferential direction of the inner wall surface 24 of the case member 12, the initial discharge start voltage begins going up from the number of discharges of substantially 200,000 times to cause the initial discharge delay.

Furthermore, as shown in FIG. 18, in the case of a discharge tube according to a comparative example, in which 14 triggering discharge films 28 are disposed at an equal interval in a circumferential direction of the inner wall surface 24 of the case member 12, similarly to the fourth discharge tube 44 according to the invention, the initial discharge start voltage can be inhibited from going up; however, when the number of discharges exceeds substantially 600,000 times, the following discharge start voltage begins decreasing to be incapable of using.

Since both ends of each of the triggering discharge films 28 of the fourth discharge tube 44 according to the invention are disposed separated by a small discharge gap 26 from the cap members 14, 14 that double as a discharge electrode, as far as the electrode material that is splashed by sputtering the discharge electrode portion 18 does not stick to both of the small discharge gaps 26 disposed at both ends of the triggering discharge film 28, the insulation deterioration is not caused. Accordingly, the fourth discharge tube 44 according to the invention, in comparison with an existing discharge tube 60 formed by oppositely disposing a pair of triggering discharge films 78, 78 with a small discharge gap 76 apart, can suppress the insulation deterioration from occurring.

In this case, since the triggering discharge film 28 is not electrically connected to the cap members 14, 14 that double as a discharge electrode, an extent of concentration of an electric field in the small discharge gap 26 is suppressed. However, as mentioned above, since the film 30 containing an alkali iodide that is small in the work function and excellent in the electron emission characteristics is formed on a surface of the discharge electrode portion 18, high responsiveness is not damaged.

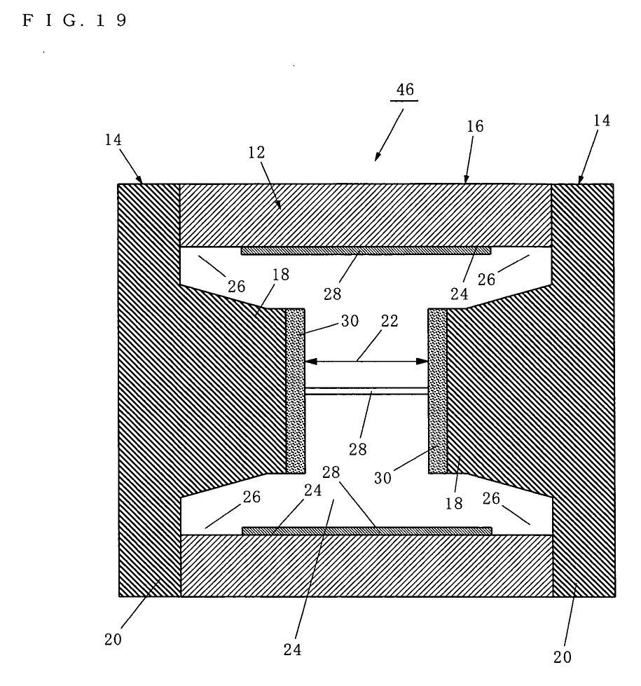

FIG. 19 shows a fifth discharge tube 46 according to the invention. The fifth discharge tube 46 corresponds to claims 8 and 9. Constituent members same as that of the first discharge tube 10 will be given the same reference numerals.

The fifth discharge tube 46 according to the invention is formed, as shown in FIG. 19, by forming an airtight envelope 16 by hermetically sealing openings at both ends of a cylindrical case member 12 made of ceramics as an insulating material opened at both ends thereof with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed. The discharge gap 22 is set at, for instance, substantially 1.5 mm.

The cap member 14 provided with the discharge electrode portion 18 and the connection portion 20 is constituted of oxygen-free copper or zirconium copper obtained by containing zirconium (Zr) in oxygen-free copper. The end surface of the case member 12 and the connection portion 20 of the cap member 14 are hermetically sealed through a sealing member such as silver solder (not shown in the drawing).

In the airtight envelope 16, a predetermined discharge gas is encapsulated. As the discharge gas, for instance, a simple substance of a rare gas such as argon, neon, helium or xenon or an inert gas such as nitrogen or a mixture thereof corresponds thereto. Furthermore, a mixture gas of a simple substance of a rare gas or an inert gas or a gas mixture thereof and a negative polarity gas such as H₂ corresponds thereto.

Furthermore, on the inner wall surface 24 of the case member 12, a plurality of linear triggering discharge films 28 of which both ends are disposed separated by a small discharge gap 26 from the cap members 14, 14 that double as a discharge electrode is formed.

The triggering discharge film 28 is constituted of a carbon base material of which primary raw material is carbon nanotubes. Specifically, it is constituted of a carbon base material that is obtained by impregnating a sintered body of a mixture in which carbon nanotubes that are a primary raw material and amorphous carbon are blended at a ratio of 80% to 20% with silicone oil. The amorphous carbon works as a binder, and, through the amorphous carbon, carbon nanotubes can be bound strongly with each other.

The carbon nanotube is an electrical conductor in which a graphite structure made of continuation of six-membered rings of carbon atoms forms a cylinder and that is low in the work function, a tip end portion thereof being conical, that is, very sharp. Furthermore, the carbon nanotube is such slender as a diameter is in the range of substantially two to several tens nanometers and a length is in the range of substantially 0.5 to 1 μm, an aspect ratio that is a ratio of height to diameter being large. Thus, the carbon nanotube is sharp at the tip end portion and large in the aspect ratio; accordingly, an electric field is concentrated at the tip end portion and excellent electron emission characteristics are provided. As the carbon nanotube, not only a single layer carbon nanotube but also a multi-layer carbon nanotube formed by concentrically stacking a plurality of cylindrical graphite structures can be used.

The triggering discharge film 28 can be formed by rubbing a core material that is constituted of a carbon base material obtained by impregnating a sintered body of a mixture of carbon nanotubes and amorphous carbon with silicone oil on the inner wall surface 24 of the case member 12 to adhere the carbon base material.

In this case, by impregnating a sintered body of a mixture of carbon nanotubes and amorphous carbon with silicone oil, the adhesiveness of the carbon base material when the core material is rubbed against the inner wall surface 24 of the case member 12 can be improved.

The silicone oil generates impurity gases. However, in the course of formation of the airtight envelope 16, silicone oil is vaporized and evacuated. Accordingly, it does not adversely affect on a discharge gas composition in the airtight envelope 16. That is, the airtight envelope 16 is formed by, in a heating atmosphere of substantially 800° C., after evacuating the inside of the case member 12, introducing a predetermined discharge gas, followed by hermetically sealing the case member 12 and the cap member 14 through a sealing material to form. Accordingly, the silicone oil is vaporized in a heating atmosphere at substantially 800° C. and evacuated in the course of vacuum evacuation.

On a surface of the discharge electrode portion 18, an insulating film 30 that contains an alkali iodide effective in stabilizing the discharge start voltage is formed. The film 30 can be formed by coating one obtained by adding a simple substance of an alkali iodide such as potassium iodide (KI), sodium iodide (NaI), cesium iodide (CsI) or rubidium iodide (RbI) or a mixture thereof in a binder made of a sodium silicate solution and pure water on a surface of the discharge electrode portion 18.

In this case, the simple substance of an alkali iodide or a mixture thereof is mixed at a ratio in the range of 0.01 to 70% by weight and the binder is mixed at a ratio in the range of 99.99 to 30% by weight. Furthermore, mixing ratios of a sodium silicate solution and pure water in the binder are in the range of 0.01 to 70% by weight for the sodium silicate solution and in the range of 99.99 to 30% by weight for the pure water.

When at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the fifth discharge tube 46 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added in the film 30 together with the bromide or without the bromide, the discharge start voltage of the fifth discharge tube 46 can be stabilized.

These substances are added at a compounding ratio in the range of 0.01 to 10% by weight in the mixture of the simple substance of the alkali iodide or mixture thereof and the binder.

The insulating film 30 that contains an alkali iodide, being small in the work function and excellent in the electron emission characteristics, works so as to lower the discharge start voltage. In particular, when one in which potassium iodide (KI) is added to a binder made of a sodium silicate solution and pure water is coated to form the film 30, the discharge start voltage can be remarkably lowered.

In this case, when a compounding ratio of potassium iodide added to the binder (a compounding ratio of the sodium silicate solution and pure water is 1:1) exceeds 40% by weight, potassium iodide saturates in the solubility to the binder and is not dissolved further. Accordingly, a compounding ratio of potassium iodide is preferably in the range of 0.1 to 40% by weight, and when the compounding ratio of potassium iodide is 40% by weight, the discharge start voltage is most largely lowered.

In the fifth discharge tube 46 according to the invention, when between the pair of cap members 14, 14 that double as a discharge electrode a voltage equal to or more than the discharge start voltage of the fifth discharge tube 46 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge.

Thus, in the fifth discharge tube 46 according to the invention, since the triggering discharge film 28 is constituted of a carbon base material of which primary raw material is carbon nanotube excellent in the electron emission characteristics, initial electrons can be supplied abundantly; as a result, the initial discharge start voltage can be inhibited from going up and thereby a discharge tube that does not cause the initial discharge delay and is long in the lifetime can be realized.

Furthermore, in the triggering discharge film 28 according to the invention, which is constituted of a carbon base material of which primary raw material is carbon nanotube, slender carbon nanotubes, being entangled with fine irregularities on a surface of the inner wall 24 of the case member 12 to be large in the adhesiveness with the inner wall surface 24 of the case member, are hardly peeled; accordingly, the inhibition function of the initial discharge delay can be sufficiently exhibited.

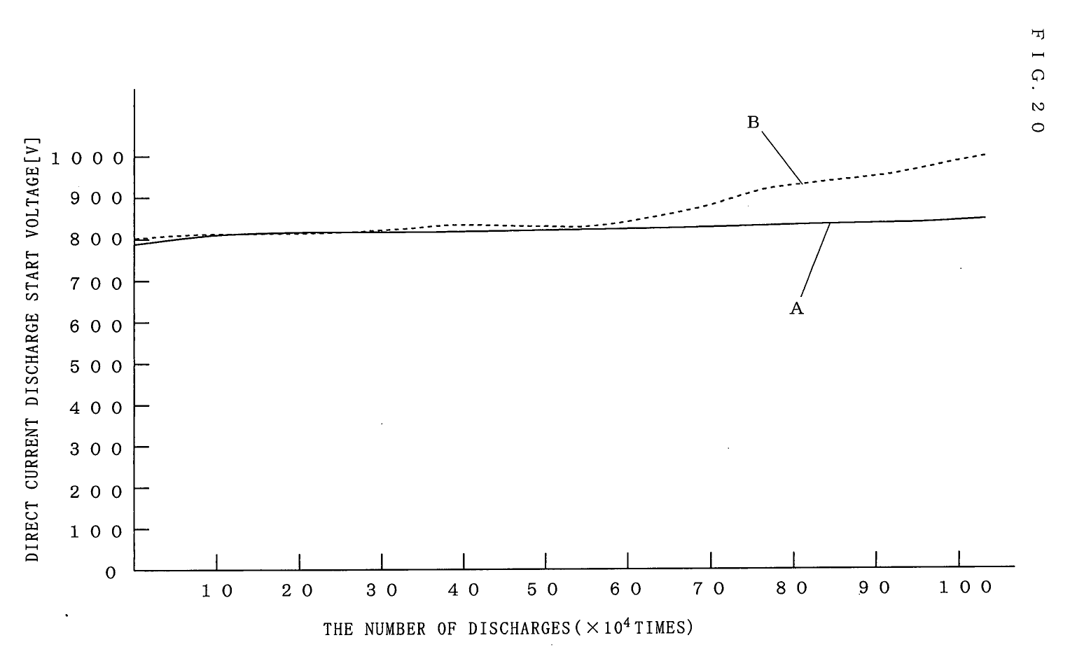

FIG. 20 is a graph showing relationship between the number of discharges and the initial discharge start voltage in the fifth discharge tube 46 according to the invention, in which the triggering discharge film 28 is constituted of a carbon base material obtained by impregnating a sintered body of a mixture of carbon nanotubes and amorphous carbon with silicone oil, and a discharge tube in which the triggering discharge film 28 is constituted of a carbon base material of which primary raw material is graphite. As shown in the graph, while in the case of the discharge tube (graph B of FIG. 20) where the triggering discharge film 28 is constituted of a carbon base material of which primary raw material is graphite, after the number of discharges reaches substantially 600,000 times, the initial discharge start voltage begins going up and the initial discharge delay is generated, in the case of the fifth discharge tube 46 according to the invention (graph A of FIG. 20), even after the number of discharges exceeds one million times, the initial discharge start voltage does not exhibit a large change; accordingly, without causing the initial discharge delay, longer lifetime is realized.

Since both ends of each of the triggering discharge films 28 of the fifth discharge tube 46 according to the invention are disposed separated by a small discharge gap 26 from the cap members 14, 14 that double as a discharge electrode, as far as the electrode material that is splashed by sputtering the discharge electrode portion 18 does not stick to both of the small discharge gaps 26 disposed at both ends of the triggering discharge film 28, the insulation deterioration is not caused. Accordingly, the fifth discharge tube 46 according to the invention, in comparison with an existing discharge tube 60 formed by oppositely disposing a pair of triggering discharge films 78, 78 separated by a small discharge gap 76, can suppress the insulation deterioration from occurring.

In this case, since the triggering discharge film 28 is not electrically connected to the cap members 14, 14 that double as a discharge electrode, an extent of concentration of an electric field in the small discharge gap 26 is suppressed. However, as mentioned above, since the triggering discharge film 28 is constituted of a carbon base material of which primary raw material is carbon nanotubes excellent in the electron emission characteristics and also on a surface of the discharge electrode portion 18 a film 30 containing an alkali iodide that is small in the work function and excellent in the electron emission characteristics is formed, high responsiveness is not damaged.

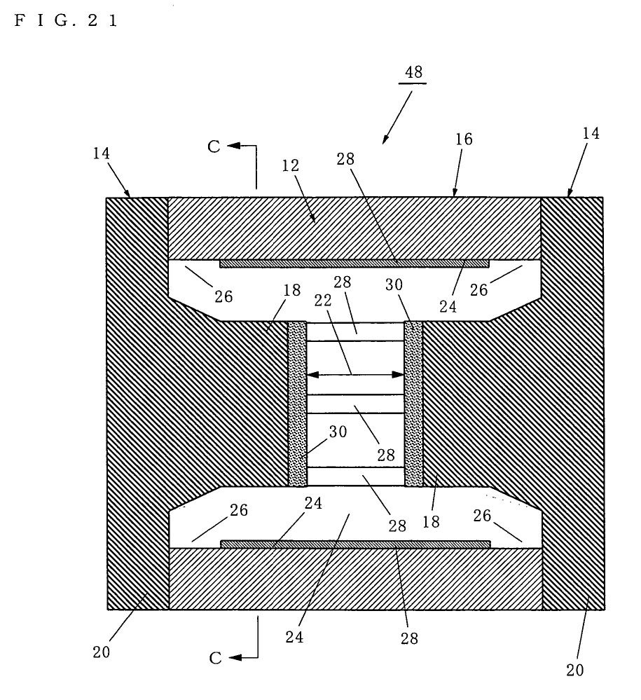

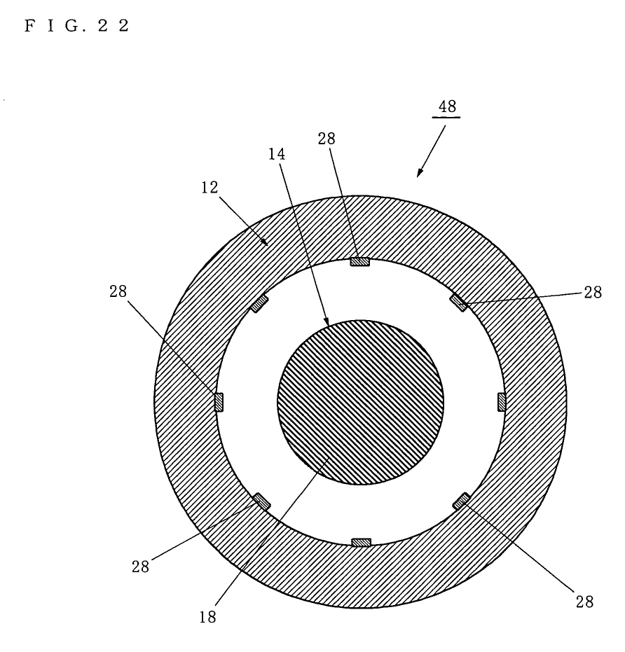

FIGS. 21 and 22 show a sixth discharge tube 48 according to the invention. The sixth discharge tube 48 corresponds to claims 10 and 11. Constituent members same as that of the first discharge tube 10 will be given the same reference numerals.

The sixth discharge tube 48 according to the invention is formed by forming an airtight envelope 16, as shown in FIGS. 21 and 22, by hermetically sealing openings at both ends of a cylindrical case member 12 made of ceramics as an insulating material opened at both ends with a pair of cap members 14, 14 that double as a discharge electrode.

A cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed.

The cap member 14 provided with the discharge electrode portion 18 and the connection portion 20 is constituted of oxygen-free copper or zirconium copper obtained by containing zirconium (Zr) in oxygen-free copper. The end surface of the case member 12 and the connection portion 20 of the cap member 14 are hermetically sealed through a sealing member such as silver solder (not shown in the drawing).

Furthermore, on an inner wall surface 24 of the case member 12, a plurality of linear triggering discharge films 28 of which both ends are disposed opposite to the cap members 14, 14 that double as a discharge electrode separated by a small discharge gap 26 is formed. In FIGS. 21 and 22, a case where the triggering discharge films 28 are formed by eight at an interval of 45° in a circumferential direction of the inner wall surface 24 of the case member 12 is exemplified.

The triggering discharge film 28 is constituted of an electrically conductive material such as a carbon base material. The triggering discharge film 28 can be formed by rubbing a core material made of, for instance, a carbon base material to stick.

On a surface of the discharge electrode portion 18, an insulating film 30 containing potassium iodide (KI) is formed. The film 30, being effective in stabilizing the discharge start voltage and small in the work function to be excellent in the electron emission characteristics, works so as to lower the discharge start voltage.

The film 30 can be formed by coating (covering) one obtained by adding potassium iodide to a binder made of a sodium silicate solution and pure water on a surface of the discharge electrode portion 18.

In this case, an amount of potassium iodide added to the binder made of a sodium silicate solution and pure water is set in the range of 0.01 to 23% by weight, and preferably in the range of 5 to 15% by weight.

Furthermore, compounding ratios of a sodium silicate solution and pure water in the binder are set in the range of 50 to 67% by weight, and preferably at 60% by weight for the sodium silicate solution, and in the range of 50 to 33% by weight, and preferably at 40% by weight for pure water.

When at least one kind of bromides such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added to the film 30, the discharge start voltage of the sixth discharge tube 48 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added to the film 30 together with the bromide or without the bromide, the discharge start voltage of the sixth discharge tube 48 can be stabilized.

These substances are added at a compounding ratio in the range of 0.01 to 10% by weight in the mixture of potassium iodide and the binder.

In the airtight envelope 16, a predetermined discharge gas is encapsulated. As the discharge gas, for instance, a simple substance of a rare gas such as argon, neon, helium or xenon or an inert gas such as nitrogen or a mixture thereof corresponds thereto. Furthermore, a mixture gas of a simple substance of a rare gas or an inert gas or a gas mixture thereof and a negative polarity gas such as H₂ corresponds thereto.

In the sixth discharge tube 48 according to the invention, when between the pair of cap members 14, 14 that double as a discharge electrode a voltage equal to or more than the discharge start voltage of the sixth discharge tube 48 is applied, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge.

Incidentally, since both ends of each of the triggering discharge films 28 of the sixth discharge tube 48 according to the invention are disposed separated by a small discharge gap 26 from the cap members 14, 14 that double as a discharge electrode, as far as the electrode material that is splashed by sputtering the discharge electrode portion 18 does not stick to both of the small discharge gaps 26 disposed at both ends of the triggering discharge film 28, the insulation deterioration is not caused. Accordingly, the sixth discharge tube 48 according to the invention, in comparison with an existing discharge tube 60 formed by oppositely disposing a pair of triggering discharge films 78, 78 separated by a small discharge gap 76, can suppress the insulation deterioration from occurring.

In this case, since the triggering discharge film 28 is not electrically connected to the cap members 14, 14 that double as a discharge electrode, an extent of concentration of an electric field in the small discharge gap 26 is suppressed. However, as mentioned above, since on a surface of the discharge electrode portion 18 the film 30 small in the work function and excellent in the electron emission characteristics is formed, high responsiveness is not damaged.

Thus, in the sixth discharge tube 48 according to the invention, an amount of potassium iodide added to the binder made of a sodium silicate solution and pure water is set in the range of 0.01 to 23% by weight. Accordingly, even when it is used under a high temperature environment, the fluctuations in the discharge start voltage can be suppressed low.

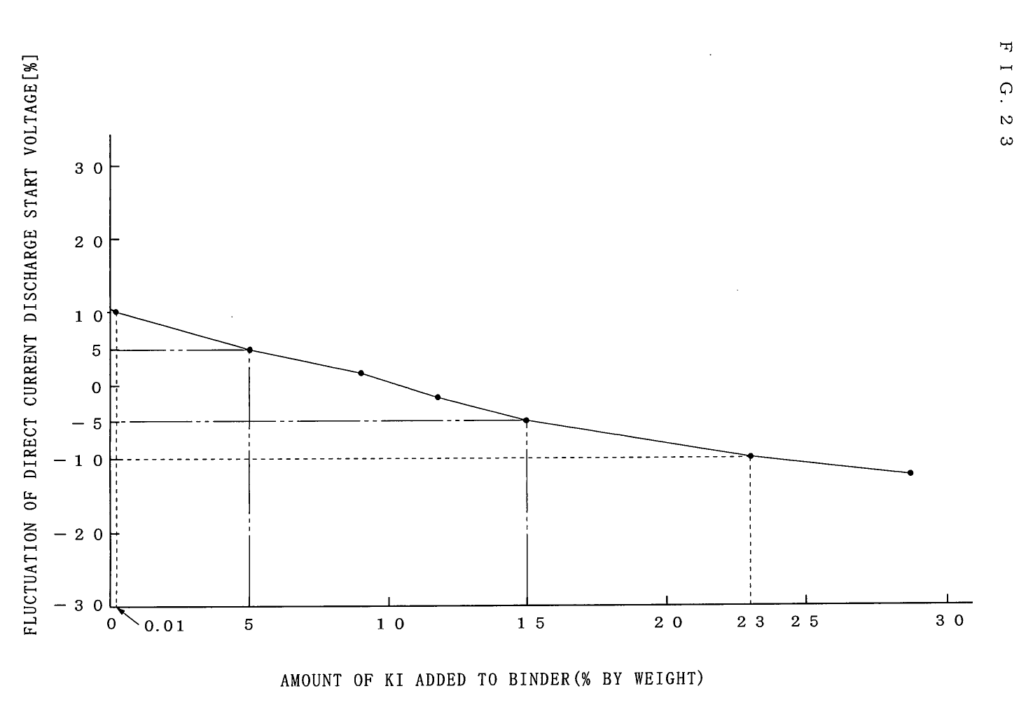

FIG. 23 is a graph showing relationship between an amount of potassium iodide (KI) added to the binder and the fluctuations in the direct current discharge start voltage when the sixth discharge tube 48 according to the invention, after heating at 150° C., is left to stand for 50 hr. In the sixth discharge tube 48 that is used, the discharge electrode portion 18 is constituted of oxygen-free copper, the discharge gas is constituted of argon, and a compounding ratio of the sodium silicate solution to pure water in the binder is 60% by weight: 40% by weight.

When the fluctuations of the direct current discharge start voltage are within ±10%, there is no practical problem. As shown in a graph of FIG. 23, when an amount of potassium iodide added to the binder is in the range of 0.01 to 23% by weight, the fluctuations of the discharge start voltages can be suppressed within ±10%. Furthermore, when an amount of potassium iodide added to the binder is in the range of 5 to 15% by weight, the fluctuations of the discharge start voltages can be more preferably suppressed within ±5%.

When an amount of the sodium silicate solution in the binder is much, since the viscosity of the binder becomes higher, a film thickness of the film 30 obtained by coating (covering) the binder on a surface of the discharge electrode portion 18 tends to be irregular, resulting in causing the fluctuations in the discharge start voltages.

On the other hand, when an amount of the sodium silicate solution in the binder is less, since the viscosity of the binder becomes lower, the adhesiveness of the film 30 with the surface of the discharge electrode portion 18 becomes small. As a result, the film 30 becomes likely to be readily sputtered and the deterioration of the lifetime characteristics is caused.

From the above, the compounding ratios of the sodium silicate solution and pure water in the binder are suitable to be, as mentioned above, in the range of 50 to 67% by weight and preferably 60% by weight for the sodium silicate solution and in the range of 50 to 33% by weight and preferably 40% by weight for pure water.

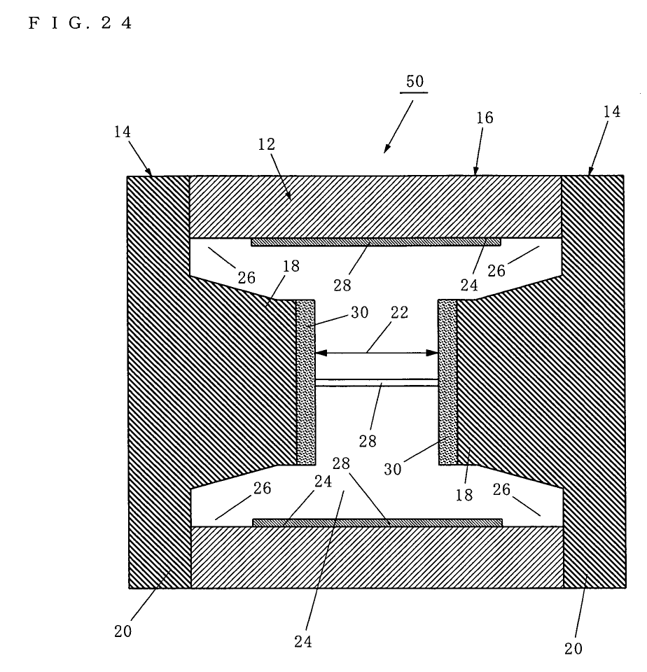

FIG. 24 shows a surge absorber 50 according to the invention. The surge absorber 50 corresponds to claims 12 and 13. Constituent members same as that of the first discharge tube 10 will be given the same reference numerals.

The surge absorber 50 according to the invention is formed, as shown in FIG. 24, by forming an airtight envelope 16 by hermetically sealing openings at both ends of a cylindrical case member 12 made of ceramics as an insulating material opened at both ends with a pair of cap members 14, 14 that double as a discharge electrode.

The cap member 14 includes a planar discharge electrode portion 18 largely protruded toward a center of the airtight envelope 16 and a connection portion 20 that is in contact with an end surface of the case member 12. Between the discharge electrode portions 18, 18 of the both cap members 14, 14, a predetermined discharge gap 22 is formed.

The cap member 14 provided with the discharge electrode portion 18 and the connection portion 20 is constituted of oxygen-free copper or zirconium copper obtained by containing zirconium (Zr) in oxygen-free copper.

The end surface of the case member 12 and the connection portion 20 of the cap member 14 are hermetically sealed through a sealing member such as silver solder (not shown in the drawing).

Furthermore, on an inner wall surface 24 of the case member 12, a plurality of linear triggering discharge films 28 of which both ends are disposed opposite to the cap members 14, 14 that double as a discharge electrode separated by a small discharge gap 26 is formed. The triggering discharge film 28 is constituted of an electrically conductive material such as a carbon base material. The triggering discharge films 28 can be formed by, for instance, rubbing a carbon base material to stick.

In the airtight envelope 16, a predetermined discharge gas is encapsulated. As the discharge gas, for instance, a simple substance of a rare gas such as argon, neon, helium and xenon or an inert gas such as nitrogen or a mixture thereof corresponds thereto. Furthermore, a mixture gas of a simple substance of a rare gas or an inert gas or a gas mixture thereof and a negative polarity gas such as H₂ corresponds thereto.

On a surface of the discharge electrode portion 18, an insulating film 30 that contains an alkali iodide effective in stabilizing the discharge start voltage is formed. The film 30 can be formed by coating one obtained by adding a simple substance of an alkali iodide such as potassium iodide (KI), sodium iodide (NaI), cesium iodide (CsI) and rubidium iodide (RbI) or a mixture thereof in a binder made of a sodium silicate solution and pure water on a surface of the discharge electrode portion 18.

In this case, the simple substance of an alkali iodide or a mixture thereof is mixed at a ratio in the range of 0.01 to 70% by weight and the binder is mixed at a ratio in the range of 99.99 to 30% by weight. Furthermore, mixing ratios of a sodium silicate solution and pure water in the binder are in the range of 0.01 to 70% by weight for the sodium silicate solution and in the range of 99.99 to 30% by weight for the pure water.

When at least one kind of bromide such as cesium bromide (CsBr), rubidium bromide (RbBr), nickel bromide (NiBr₂), indium bromide (InBr₃), cobalt bromide (CoBr₂) and iron bromide (FeBr₂, FeBr₃) is added in the film 30, the discharge start voltage of the surge absorber 50 can be further stabilized.

Also when at least one kind of barium chloride (BaCl), barium fluoride (BaF), yttrium oxide (Y₂O₃), yttrium chloride (YCl₂), yttrium fluoride (YF₃), potassium molybdate (K₂MoO₄), potassium tungstate (K₂WO₄), cesium chromate (Cs₂CrO₄), praseodymium oxide (Pr₆O₁₁) and potassium titanate (K₂Ti₄O₉) is added in the film 30 together with the bromide or without the bromide, the discharge start voltage of the surge absorber 50 can be stabilized.

These substances are added at a compounding ratio in the range of 0.01 to 10% by weight in the mixture of the simple substance of the alkali iodide or mixture thereof and the binder.

The insulating film 30 that contains an alkali iodide, being small in the work function and excellent in the electron emission characteristics, works so as to lower the discharge start voltage. In particular, when one in which potassium iodide (KI) is added to a binder made of a sodium silicate solution and pure water is coated to form the film 30, the discharge start voltage can be remarkably lowered.

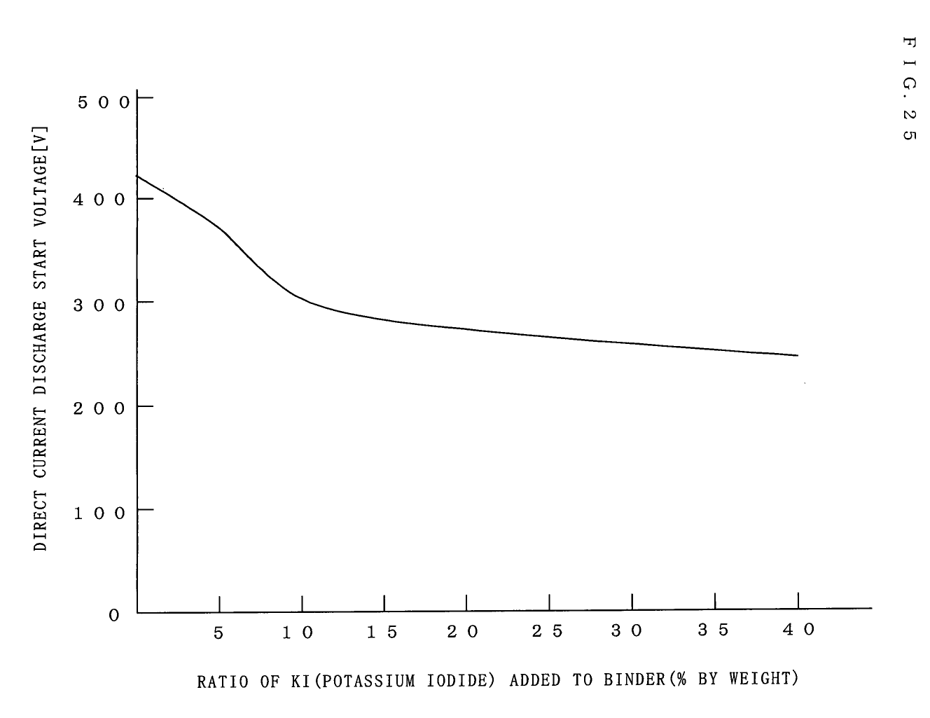

FIG. 25 is a graph showing relationship between a ratio (% by weight) of potassium iodide added to the binder made of a sodium silicate solution and pure water (a compounding ratio of the sodium silicate solution and pure water is 1:1) and the direct current discharge start voltage of the surge absorber 50. As the surge absorber 50, one where argon is encapsulated as the discharge gas at a gas pressure of 120 kPa and the discharge gap 22 between the discharge electrode portions 18, 18 is set at 0.55 mm is used.

As obvious from the graph of FIG. 25, as a compounding ratio of potassium iodide added to the binder made of a sodium silicate solution and pure water (a compounding ratio of a sodium silicate solution to pure water is 1:1) becomes larger, the direct current discharge start voltage becomes lower.

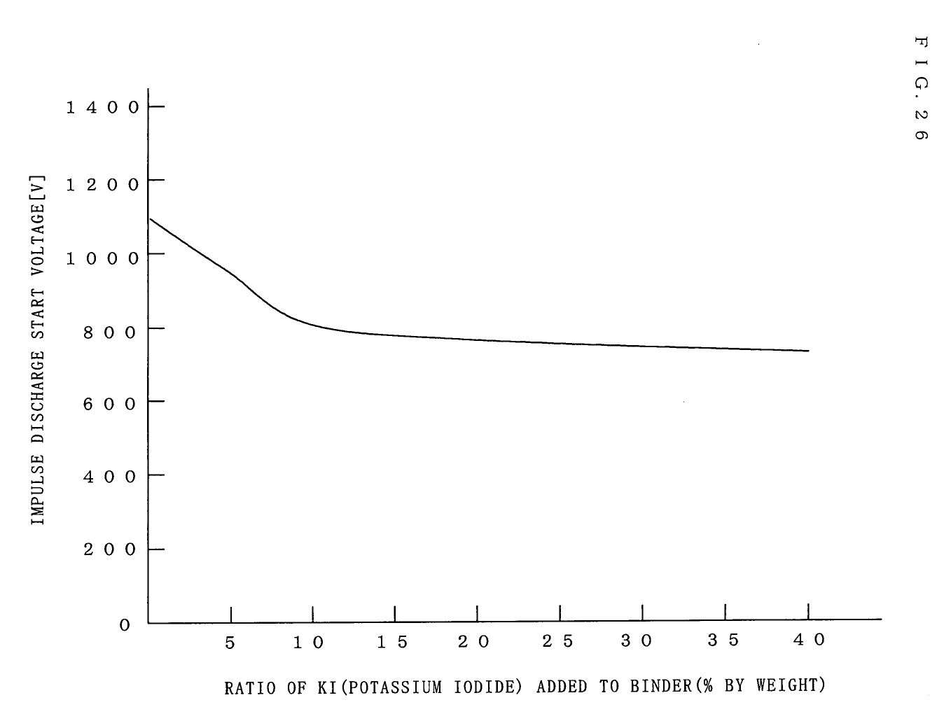

Furthermore, FIG. 26 is a graph showing relationship between a ratio (% by weight) of potassium iodide added to the binder made of a sodium silicate solution and pure water (a compounding ratio of the sodium silicate solution and pure water is 1:1) and the impulse discharge start voltage of the surge absorber 50. As the surge absorber 50, one where argon is encapsulated as the discharge gas at a gas pressure of 120 kPa and the discharge gap 22 between the discharge electrode portions 18, 18 is set at 0.55 mm is used, and an impulse voltage of 2.5 kV is applied at 1.2/50 μs to measure.

As obvious from the graph of FIG. 26, as a compounding ratio of potassium iodide added to the binder made of a sodium silicate solution and pure water (a compounding ratio of a sodium silicate solution to pure water is 1:1) becomes larger, the impulse discharge start voltage decreases.

In this case, when a compounding ratio of potassium iodide added to the binder (a compounding ratio of the sodium silicate solution and pure water is 1:1) exceeds 40% by weight, potassium iodide saturates in the solubility to the binder and is not dissolved further. Accordingly, a compounding ratio of potassium iodide is preferably in the range of 0.1 to 40% by weight, and when the compounding ratio of potassium iodide is 40% by weight, the discharge start voltage is most largely lowered.

When a surge is applied through the cap members 14, 14 that double as a discharge electrode to the surge absorber 50 according to the invention, an electric field is concentrated at the small discharge gap 26 between both ends of the triggering discharge film 28 and the cap members 14, 14, thereby electrons are emitted in the small discharge gap 26, and thereby the creeping corona discharge as the trigger discharge is generated. Subsequently, the creeping corona discharge shifts to the glow discharge owing to the priming effect of electrons. Then, the glow discharge spreads to a discharge gap 22 between the discharge electrode portions 18, 18, and shifts to an arc discharge as a primary discharge to absorb the surge.

Thus, in the surge absorber 50 according to the invention, since both ends of each of the triggering discharge films 28 are disposed a small discharge gap 26 apart from the cap members 14, 14 that double as a discharge electrode, as far as the electrode material that is splashed by sputtering the discharge electrode portion 18 does not stick to both of the small discharge gaps 26 disposed at both ends of the triggering discharge film 28, the insulation deterioration is not caused. Accordingly, the surge absorber 50 according to the invention, in comparison with an existing surge absorber 60 formed by oppositely disposing a pair of triggering discharge films 78, 78 a small discharge gap 76 apart, can suppress the insulation deterioration from occurring and thereby can realize the longer lifetime of the surge absorber 50.

In addition, since the triggering discharge film 28 is not electrically connected to the cap members 14, 14 that double as a discharge electrode, electrons emitted are limited in an amount thereof in the small discharge gap 26. However, since a film 30 containing an alkali iodide that is small in the work function and excellent in the electron emission characteristics is formed on a surface of the discharge electrode portion 18, high responsiveness is secured as well.

1. A discharge tube characterized in that in an airtight envelope a plurality of discharge electrodes is disposed a discharge gap apart and a discharge gas containing Kr is encapsulated in the airtight envelope.

2. The discharge tube according to claim 1 characterized in that the discharge gas is constituted of a mixture gas of Kr and H₂.

3. The discharge tube according to claim 1 characterized in that the discharge gas is constituted of a mixture gas of Kr and Ar.

4. The discharge tube according to claim 1 characterized in that the discharge gas is constituted of a mixture gas of Kr and Ne.

5. A discharge tube that is formed by disposing a plurality of discharge electrodes separated by a discharge gap followed by encapsulating in an airtight envelope together with a discharge gas characterized in that the discharge electrodes are made of zirconium copper obtained by containing zirconium in oxygen-free copper.

6. A discharge tube that is formed by disposing a plurality of discharge electrodes, which is made of oxygen-free copper, separated by a discharge gap followed by encapsulating in an airtight envelope together with a discharge gas characterized in that the discharge gas is constituted of argon and the argon is encapsulated in the airtight envelope at a pressure in the range of 0.3 to 5 atmospheric pressures.

7. A discharge tube that is formed by forming an airtight envelope by hermetically sealing openings at both ends of a cylindrical case member made of an insulating material opened at both ends with a pair of cap members that double a discharge electrode, encapsulating a discharge gas in the airtight envelope, forming a discharge gap between discharge electrode portions of the cap member disposed in the airtight envelope, and forming on an inner wall surface of the case member a triggering discharge film of which both ends are disposed separated by a small discharge gap from the cap members, characterized in that the triggering discharge films are formed in the range of 8 to 12 in a circumferential direction of the inner wall surface of the case member at an equal interval.

8. A discharge tube that is formed by forming an airtight envelope by hermetically sealing openings at both ends of a case member made of an insulating material opened at both ends with a pair of cap members that double a discharge electrode, encapsulating a discharge gas in the airtight envelope, forming a discharge gap between discharge electrode portions of the cap member disposed in the airtight envelope, and forming on an inner wall surface of the case member a triggering discharge film of which both ends are disposed separated by a small discharge gap from the cap member, characterized in that the triggering discharge film is made of a carbon base material of which primary raw material is carbon nanotube.

9. The discharge tube according to claim 8 characterized in that the triggering discharge film is made of a carbon base material obtained by impregnating a sintered body of a mixture of carbon nanotubes and amorphous carbon with silicone oil.

10. A discharge tube that is formed by disposing a plurality of discharge electrodes separated by a discharge gap followed by encapsulating in an airtight envelope together with a discharge gas, and on a surface of the discharge electrode forming a film containing potassium iodide by coating one obtained by adding potassium iodide to a binder made of a sodium silicate solution and pure water, characterized in that an amount of the potassium iodide added to the binder is in the range of 0.01 to 23% by weight.

11. The discharge tube according to claim 10 characterized in that an amount of the potassium iodide added to the binder is set in the range of 5 to 15% by weight.

12. A surge absorber characterized by forming an airtight envelope by hermetically sealing openings at both ends of a case member made of an insulating material opened at both ends with a pair of cap members that double a discharge electrode, encapsulating a discharge gas in the airtight envelope, forming a discharge gap between discharge electrode portions of the cap member disposed in the airtight envelope, forming on an inner wall surface of the case member a triggering discharge film of which both ends are disposed separated by a small discharge gap from the cap members, and forming on a surface of the discharge electrode portion a film containing an alkali iodide.

13. The surge absorber according to claim 12 characterized in that the alkali iodide is a simple substance of potassium iodide (KI), sodium iodide (NaI), cesium iodide (CsI) and rubidium iodide (RbI) or a mixture thereof.
